(19) United States
(12) Patent Application Publication
(10) Pub. No.: US 2010/0130674 A1
(43) Pub. Date: May 27, 2010

(54) METHOD FOR THE PRODUCTION OF POLYURETHANE COMPOSITIONS WITH A LOW ISOCYANATE MONOMER CONTENT

(75) Inventor: Urs Burckhardt, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/449,624

(22) PCT Filed: Mar. 28, 2008
(86) PCT No.: PCT/EP2008/053709

§ 371 Date: Aug. 21, 2009

(30) Foreign Application Priority Data
Mar. 28, 2007 (EP) 07105145.2

(51) Int. Cl. C08L 75/04; B29C 65/52; F16J 15/02

(52) U.S. Cl. 524/589; 156/331.7; 277/312

(57) ABSTRACT

The person invention relates to a method for the production of a polyurethane composition with a low isocyanate monomer content. In said method, at least one polyurethane polymer comprising isocyanate groups is reacted with at least one compound VB, wherein the compound VB comprises a group carrying an active hydrogen that represents a hydroxyl group or a mercapto group or a secondary amino group and at least one blocked amino group selected from the group consisting of aldimino groups of the formula (Ia) or (Ib), ketimino groups, enamino groups, and oxazolidino groups. Using said method, compositions are obtained in a cost-effective, efficient, and elegant manner having an extremely reduced monomeric diisocyanate content, said compositions being particularly suitable as hot-melt adhesives.

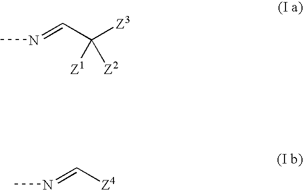

### TECHNICAL FIELD

The invention relates to the field of polyurethane compositions having isocyanate groups, especially of polyurethane compositions which have isocyanate groups and a low content of monomeric diisocyanates.

### STATE OF THE ART

A problem which occurs when polyurethane polymers having isocyanate groups are used is that of the residual content of monomeric diisocyanates. Owing to the random distribution of the possible reaction products, the reaction of polyols with diisocyanates to give polyurethane polymers, or the preparation of diisocyanate oligomers, always leaves a greater or lesser residual content of unconverted monomeric diisocyanates in the reaction product. These monomeric diisocyanates, also referred to as “isocyanate monomers” for short, are volatile compounds and can be harmful owing to their irritant, allergenic and/or toxic action. In many fields of use, they are therefore undesired. This is especially true of spray applications and of compositions to be processed while hot, for example hotmelt adhesives.

Various ways of lowering the proportion of monomeric diisocyanates in polyurethane polymers having isocyanate groups have been described. For example, the monomeric diisocyanates can be partly or completely removed subsequently from the polyurethane polymer having isocyanate groups, for example by extraction or distillation, as disclosed, for example, by WO 01/014443 A1, which, though, is complicated and therefore costly. A low NCO/OH ratio in the preparation of polyurethane polymers having isocyanate groups leads directly to a relatively low isocyanate monomer content; however, polymers thus prepared, owing to oligomerization reactions (“chain extension”), have an increased viscosity and are thus generally more difficult to process and less storage-stable. The use of an asymmetric diisocyanate with two isocyanate groups of different reactivity, as described, for example, in WO 03/006521 A1, likewise leads directly to a relatively low content of monomeric diisocyanates. The thus obtainable polyurethane polymers having isocyanate groups, however, generally have slowed crosslinking, since principally only the less reactive of the two isocyanate groups is available for the crosslinking reaction.

### SUMMARY OF THE INVENTION

It is therefore an object of the present invention to provide a process for preparing polyurethane polymers which have isocyanate groups and have a low content of monomeric diisocyanates, which is capable of overcoming the disadvantages of the prior art.

It has been found that, surprisingly, a process as claimed in claim 1 can achieve this object. This process is extremely efficient and inexpensive, and additionally has the advantage that the double functionality of the monomers is not lost, such that they can be incorporated profitably into the high molecular weight polymer which forms as the polyurethane polymers are crosslinked.

By means of this process, it is possible to form compositions which have an advantageous viscosity, are storage-stable and do not possess slowed curing. Such compositions form the subject matter of claim 19. They are suitable especially for applications in which a high isocyanate monomer content is disadvantageous, such as in spray applications or in compositions to be processed while hot, for example hotmelt adhesives.

Further aspects of the invention relate to a process for adhesive bonding as claimed in claim 20, to a process for sealing as claimed in claim 21, to a process for coating as claimed in claim 22, and to the articles resulting therefrom as claimed in claim 25.

Particularly preferred embodiments of the invention are the subject matter of the dependent claims.

### WAYS OF PERFORMING THE INVENTION

The invention provides a process for preparing a polyurethane composition with a low content of monomeric diisocyanates. In this process,
a) at least one polyurethane polymer PUP having isocyanate groups is reacted with
b) at least one compound VB,
   the compound VB being characterized in that it has both
i) a group which bears an active hydrogen and is a hydroxyl group or a mercapto group or a secondary amino group and
ii) at least one capped amino group selected from the group consisting of aldimino groups of the formula (Ia) or (Ib), ketimino groups, enamino groups and oxazolidino groups,

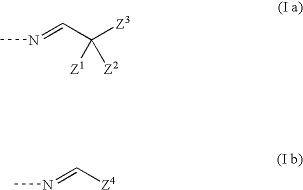

where, in formula (Ia),
Z¹ and Z² are
   each independently a hydrogen atom or a monovalent hydrocarbon radical having 1 to 12 carbon atoms,
   or
   together are a divalent hydrocarbon radical which has 4 to 20 carbon atoms and is part of an optionally substituted carbocyclic ring having 5 to 8, preferably 6, carbon atoms; and
Z³
   is a hydrogen atom,
   or is a branched or unbranched alkyl, cycloalkyl, alkylene or cycloalkylene group,
   or is a substituted or unsubstituted aryl or arylalkyl group,
   or is a radical of the formula O—R² or

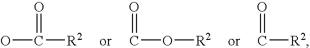

where R²
   is an aryl, arylalkyl or alkyl group and is in each case substituted
   or unsubstituted,
or is a radical of the formula (II)

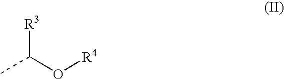

where, in formula (II),
R³ is a hydrogen atom or an alkyl or arylalkyl group, especially having 1 to 12 carbon atoms, preferably a hydrogen atom, and R⁴
   is a hydrocarbon radical which has 1 to 30 carbon atoms and optionally contains ether oxygen atoms,
   or is a

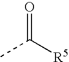

radical where R⁵ is a hydrogen atom or a hydrocarbon radical having 1 to 5 carbon atoms,

and where, in formula (Ib),
Z⁴
   is a substituted or unsubstituted aryl or heteroaryl group which has a ring size of 5 to 8, preferably 6, atoms,
   or is

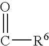

where R⁶
is a hydrogen atom or an alkoxy group,
or is a substituted or unsubstituted alkenyl or arylalkenyl group having at least 6 carbon atoms.

The proviso applies here that the ratio between the isocyanate groups of the polyurethane polymer PUP and the sum of the capped amino groups and the group of the compound VB which bears an active hydrogen has a value of ≧1.

Broken lines in the formulae in this document represent in each case the bond between a substituent and the corresponding molecular radical. In the present document, the term “polymer” firstly embraces a collective of macromolecules which are chemically homogeneous but different in relation to degree of polymerization, molar mass and chain length, which has been prepared by a poly reaction (polymerization, polyaddition, polycondensation). The term secondly also embraces derivatives of such a collective of macromolecules from poly reactions, i.e. compounds which have been obtained by reactions, for example additions or substitutions, of functional groups on given macromolecules, and which may be chemically homogeneous or chemically inhomogeneous. The term further also comprises what are known as prepolymers, i.e. reactive oligomeric preliminary adducts whose functional groups are involved in the formation of macromolecules.

The term “polyurethane polymer” embraces all polymers prepared by what is known as the diisocyanate polyaddition process. This also includes those polymers which are virtually or entirely free of urethane groups.

Examples of polyurethane polymers are polyetherpolyurethanes, polyesterpolyurethanes, polyetherpolyureas, polyureas, polyesterpolyureas, polyisocyanurates and polycarbodiimides.

In the present document, the term “active hydrogen” refers to a deprotonatable hydrogen atom bonded to a nitrogen, oxygen or sulfur atom.

In the present text, a “capped amino group” or a “latent amine” is understood to mean, without any distinction, a derivative of an amine with aliphatic primary and/or secondary amino groups, which does not contain free but exclusively capped amino groups and as a result does not enter into a direct reaction with isocyanates at least over a certain time. Contact with water hydrolyzes the capped amino groups of the latent amine completely or partially, and then the latter begins to react with isocyanates. These reactions lead to crosslinking in the case of polyurethane polymers containing isocyanate groups.

In the present document, the term “primary amino group” refers to an NH₂ group which is bonded to an organic radical, whereas the term “secondary amino group” refers to an NH group which is bonded to two organic radicals which may also together be part of a ring, and the term “tertiary amino group” or “tertiary amine nitrogen” refers to a nitrogen atom which is bonded to three organic radicals, where two of these radicals may also together be part of a ring.

“Aliphatic amino group” refers to an amino group which is bonded to an aliphatic, cycloaliphatic or arylaliphatic radical. It thus differs from an “aromatic amino group”, which is bonded directly to an aromatic or heteroaromatic radical, as, for example, in aniline or 2-aminopyridine.

In the process described, at least one polyurethane polymer PUP having isocyanate groups is used. A suitable polyurethane polymer PUP having isocyanate groups is obtainable by the reaction of at least one polyol with at least one polyisocyanate.

The polyols used for the preparation of a polyurethane polymer PUP may, for example, be the following commercially available polyols or mixtures thereof:
polyetherpolyols, also known as polyoxyalkylenepolyols or oligoetherols, which are polymerization products of ethylene oxide, 1,2-propylene oxide, 1,2- or 2,3-butylene oxide, oxetane, tetrahydrofuran or mixtures thereof, possibly polymerized with the aid of a starter molecule with two or more active hydrogen atoms, for example water, ammonia or compounds having a plurality of OH or NH groups, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-tri-methylolethane, 1,1,1-trimethylolpropane, glycerol, aniline, and mixtures of the aforementioned compounds. It is possible to use either polyoxyalkylenepolyols which have a low degree of unsaturation (measured to ASTM D-2849-69 and reported in milliequivalents of unsaturation per gram of polyol (meq/g)), prepared, for example, with the aid of double metal cyanide complex catalysts (DMC catalysts), or polyoxyalkylenepolyols with a higher degree of unsaturation, prepared, for example, with the aid of anionic catalysts such as NaOH, KOH, CsOH or alkali metal alkoxides. Particularly suitable polyetherpolyols are polyoxyalkylenediols and -triols, especially polyoxyalkylenediols. Particularly suitable polyoxyalkylene- di- and -triols are polyoxyethylenedi- and -triols and polyoxypropylenedi- and -triols.

Particularly suitable polyoxypropylenediols and -triols have a degree of unsaturation lower than 0.02 meq/g and a molecular weight in the range from 1000 to 30 000 g/mol, and also polyoxypropylenediols and -triols with a molecular weight of 400 to 8000 g/mol. In the present document, “molecular weight” or “molar mass” is always understood to mean the molecular weight average Mₙ. Especially suitable are polyoxypropylenediols with a degree of unsaturation less than 0.02 meq/g and a molecular weight in the range from 1000 to 12 000 and especially between 1000 and 8000 g/mol. Such polyetherpolyols are sold, for example, under the trade name Acclaim® by Bayer.

Likewise particularly suitable are so-called “EO-endcapped” (ethylene oxide-endcapped) polyoxypropylenediols and -triols. The latter are specific polyoxypropylenepolyoxyethylenepolyols which are obtained, for example, by alkoxylating pure polyoxypropylenepolyols with ethylene oxide on completion of the polypropoxylation, and have primary hydroxyl groups as a result.
Styrene-acrylonitrile- or acrylonitrile-methyl methacrylate-grafted polyether-polyols.
Polyesterpolyols, also known as oligoesterols, prepared by known processes, especially the polycondensation of hydroxycarboxylic acids or the polycondensation of aliphatic and/or aromatic polycarboxylic acids with di- or polyhydric alcohols.

Especially suitable polyesterpolyols are those prepared from di- to trivalent, especially divalent, alcohols, for example ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, 1,12-hydroxystearyl alcohol, 1,4-cyclohexanedimethanol, dimer fatty acid diol (dimer diol), neopentyl glycol hydroxypivalate, glycerol, 1,1,1-trimethylolpropane or mixtures of the aforementioned alcohols, with organic di- or tricarboxylic acids, especially dicarboxylic acids, or the anhydrides or esters thereof, for example succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride, or mixtures of the aforementioned acids, and also polyesterpolyols formed from lactones, for example from ε-caprolactone, and starters such as the aforementioned di- or trihydric alcohols.

Particularly suitable polyesterpolyols are polyesterdiols. Especially suitable polyesterdiols are those prepared from adipic acid, azelaic acid, sebacic acid, dodecanedicarboxylic acid, dimer fatty acid, phthalic acid, isophthaiic acid and terephthalic acid as the dicarboxylic acid, and from ethylene glycol, diethylene glycol, neopentyl glycol, 1,4-butanediol, 1,6-hexanediol, dimer fatty acid diol and 1,4-cyclohexanedimethanol as the dihydric alcohol. Also especially suitable are polyesterdiols prepared from ε-caprolactone and one of the aforementioned dihydric alcohols as the starter.

Especially suitable substances are room temperature liquid, amorphous, partly crystalline and crystalline polyesterdi- and -triols, especially polyesterdiols. Suitable room temperature liquid polyesterpolyols are solid not far below room temperature, for example at temperatures between 0° C. and 25° C., and are preferably used in combination with at least one amorphous, partly crystalline or crystalline polyesterpolyol.
Polycarbonatepolyols, as obtainable by reaction, for example, of the abovementioned alcohols—used to form the polyesterpolyols—with dialkyl carbonates such as dimethyl carbonate, diaryl carbonates such as diphenyl carbonate, or phosgene.

Particularly suitable substances are polycarbonatediols, especially amorphous polycarbonatediols.
Likewise suitable as polyols are block copolymers which bear at least two hydroxyl groups and have at least two different blocks with polyether, polyester and/or polycarbonate structure of the type described above.
Polyacrylate- and polymethacrylatepolyols.
Poly-hydroxy-functional fats and oils, for example natural fats and oils, especially castor oil; or polyols—known as oleochemical polyols—obtained by chemical modification of natural fats and oils, for example the epoxy polyesters or epoxy polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by degradation processes such as alcoholysis or ozonolysis and subsequent chemical linkage, for example by transesterification or dimerization, of the degradation products or derivatives thereof thus obtained. Suitable degradation products of natural fats and oils are especially fatty acids and fatty alcohols, and also fatty acid esters, especially the methyl esters (FAME), which can be derivatized, for example, by hydroformylation and hydrogenation to hydroxy fatty acid esters.
Polyhydrocarbonpolyols, also known as oligohydrocarbonols, for example poly-hydroxy-functional ethylene-propylene, ethylene-butylene or ethylene-propylene-diene copolymers, as produced, for example, by Kraton Polymers, or poly-hydroxy-functional copolymers of dienes such as 1,3-butadiene or diene mixtures, and vinyl monomers such as styrene, acrylonitrile or isobutylene, or poly-hydroxy-functional polybutadienepolyols, for example those which are prepared by copolymerization of 1,3-butadiene and allyl alcohol and may also be hydrogenated.
poly-hydroxy-functional acrylonitrile/butadiene copolymers, as can be prepared, for example, from epoxides or amino alcohols and carboxyl-terminated acrylonitrile/butadiene copolymers (commercially available under the Hycar® CTBN name from Hanse Chemie).

These polyols mentioned preferably have a mean molecular weight of 250-30 000 g/mol, especially of 400-20 000 g/mol, and preferably have a mean OH functionality in the range from 1.6 to 3.

In addition to these polyols mentioned, small amounts of low molecular weight di- or polyhydric alcohols, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, low molecular weight alkoxylation products of the aforementioned di- and polyhydric alcohols, and mixtures of the aforementioned alcohols, can be used additionally in the preparation of a polyurethane polymer PUP.

The polyisocyanates used for the preparation of a polyurethane polymer PUP may be commercial aliphatic, cycloaliphatic or aromatic polyisocyanates, especially diisocyanates, for example the following:

1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,10-decamethylene diisocyanate, 1,12-dodecamethylene diisocyanate, lysine diisocyanate and lysine ester diisocyanate, cyclohexane 1,3- and 1,4-diisocyanate and any desired mixtures of these isomers, 1-methyl-2,4- and -2,6-diisocyanatocyclohexane and any desired mixtures of these isomers (HTDI or H₆TDI), 1-isocyanato-3,3,5-trimethyl-5-isocyanatomethyl-cyclohexane (=isophorone diisocyanate or IPDI), perhydro-2,4′- and -4,4′-di-phenylmethane diisocyanate (HMDI or H₁₂MDI), 1,4-diisocyanato-2,2,6-trimethylcyclohexane (TMCDI), 1,3- and 1,4-bis(isocyanatomethyl)cyclo-hexane, m- and p-xylylene diisocyanate (m- and p-XDI), m- and p-tetramethyl-1,3- and -1,4-xylylene diisocyanate (m- and p-TMXDI), bis(1-isocyanato-1-methylethyl)naphthalene, 2,4- and 2,6-toluylene diisocyanate and any desired mixtures of these isomers (TDI), 4,4′-, 2,4′- and 2,2′-diphenylmethane diisocyanate and any desired mixtures of these isomers (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODD, dianisidine diisocyanate (DADI), oligomers and polymers of the aforementioned isocyanates, and any desired mixtures of the aforementioned isocyanates. Preference is given to monomeric diisocyanates, especially MDI, TDI, HDI, H₁₂MDI and IPDI.

The polyurethane polymer PUP is prepared in a known manner directly from the polyisocyanates and the polyols, or by stepwise adduction processes, as also known as chain extension reactions.

In a preferred embodiment, the polyurethane polymer PUP is prepared via a reaction of at least one polyisocyanate and at least one polyol, the isocyanate groups being present in a stoichiometric excess relative to the hydroxyl groups. The ratio between isocyanate and hydroxyl groups is advantageously 1.3 to 5, especially 1.5 to 3.

The reaction is advantageously performed at a temperature at which the polyols and polyisocyanates used and the polyurethane polymer formed are present in liquid form.

The polyurethane polymer PUP has a molecular weight of preferably more than 500 g/mol, especially one between 1000 and 50 000 g/mol, preferably one between 2000 and 30 000 g/mol.

Moreover, the polyurethane polymer PUP preferably has a mean functionality in the range from 1.8 to 3.

In a preferred embodiment, the polyurethane polymer PUP is a room temperature solid polyurethane polymer PUP1. A room temperature solid polyurethane polymer PUP1 is advantageously obtainable proceeding from polyetherpolyols, polyesterpolyols and polycarbonatepolyols. Especially suitable substances are room temperature liquid, amorphous, partly crystalline and crystalline polyester- and polycarbonatedi- and -triols, especially polyesterdiols and polycarbonatediols, though room temperature solid polyester- and polycarbonatedi- and -triols are solid not far below room temperature, for example at temperatures between 0° C. and 25° C., and are preferably used in combination with at least one amorphous, partly crystalline or crystalline polyol.

The polyester- and polycarbonatedi- and -triols advantageously have a molecular weight of 500 to 5000 g/mol.

A room temperature solid polyurethane polymer PUP1 may be crystalline, partly crystalline or amorphous. A partly crystalline or amorphous polyurethane polymer PUP1 has only limited free flow, if any, at room temperature, which means more particularly that it has a viscosity of more than 5000 Pa·s at 20° C.

The polyurethane polymer PUP1 preferably has a mean molecular weight of 1000 to 10 000 g/mol, especially of 2000 to 5000 g/mol.

In the process described, at least one compound VB is used in addition, the compound VB being characterized in that it has both

i) a group which bears an active hydrogen and is a hydroxyl group or a mercapto group or a secondary amino group and

ii) at least one capped amino group selected from the group consisting of aldimino groups of the formula (Ia) or (Ib), ketimino groups, enamino groups and oxazolidino groups.

In one embodiment, suitable compounds VB are compounds which have both a group which bears active hydrogen and at least one aldimino group of the formula (Ia) or (Ib). Such compounds VB are especially compounds VB1 which have aldimino groups and are of the formula (IIIa) or (IIIb)

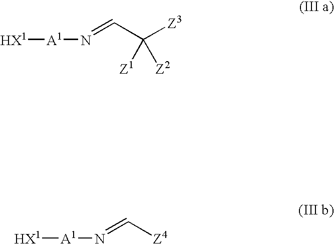

where

A¹
is a divalent hydrocarbon radical which has 2 to 20 carbon atoms and optionally has heteroatoms,
or, together with R⁸, is a trivalent hydrocarbon radical which has 3 to 20 carbon atoms and optionally contains at least one heteroatom, especially in the form of ether oxygen or tertiary amine nitrogen;

X¹ is O or S or N—R⁷ or N—R⁸,
where R⁷
is a monovalent hydrocarbon radical which has 1 to 20 carbon atoms and optionally has at least one carboxylic ester, nitrile, nitro, phosphonic ester, sulfone or sulfonic ester group,
or is a substituent of the formula (IVa) or (IVb)

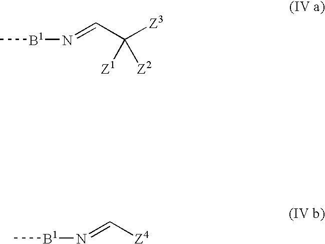

where B¹ is a divalent hydrocarbon radical which has 2 to 20 carbon atoms and optionally has heteroatoms, and
R⁸, together with A¹, is a trivalent hydrocarbon radical which has 3 to 20 carbon atoms and optionally contains at least one heteroatom, especially in the form of ether oxygen or tertiary amine nitrogen;
   and
Z¹, Z², Z³ and Z⁴ are each as already defined.

Preferably, X′ is O or N—R⁷ or N—R⁸. Additionally preferably, A¹ and/or B¹ are each an alkylene or oxyalkylene radical with a chain length of 5 atoms, especially when X¹ is O or S.

Preferred compounds VB1 of the formula (IIIa) are compounds VB1′ of the formula (V)

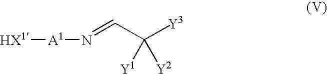

where
Y¹ and Y²
   are each independently a monovalent hydrocarbon radical having 1 to 12 carbon atoms,
   or together are a divalent hydrocarbon radical which has 4 to 12 carbon atoms and is part of an optionally substituted carbocyclic ring having 5 to 8, preferably 6, carbon atoms;
Y³
   is a branched or unbranched alkyl, cycloalkyl, alkylene or cycloalkylene group,
   or Y³ is a substituted or unsubstituted aryl or arylalkyl group,
   or is a radical of the formula O—R² or

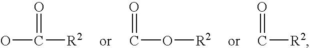

where R² is as already defined,
or is a radical of the formula (II)

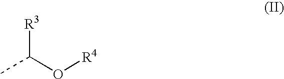

X^{1′} is O or S or N—R^{7′} or N—R⁸,
   where R^{7′}
   is a monovalent hydrocarbon radical which has 1 to 20 carbon atoms and optionally has at least one carboxylic ester, nitrile, nitro, phosphonic ester, sulfone or sulfonic ester group,
   or is a substituent of the formula (VI)

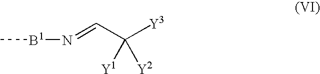

and A¹, B¹ and R⁸ are each as already defined.

In the compounds VB1′ of the formula (V), Y¹ and Y² are preferably each a methyl group. In addition, Y³ is preferably a radical of the formula (II), especially a radical of the formula (II) in which R³ is a hydrogen atom and R⁴ is

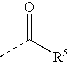

radical.

A compound VB1 of the formula (IIIa) or (IIIb) is, for example, obtainable from the reaction of at least one amine B1 of the formula (VII) with at least one aldehyde ALD of the formula (VIIIa) or (VIIIb)

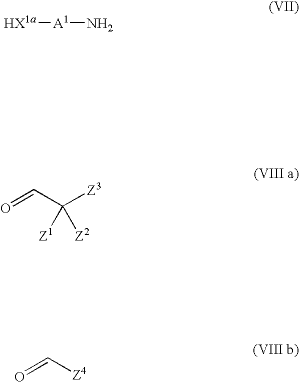

where
X^{1a} is O or S or N—R⁹ or N—R⁸,
   where R⁹
   is a monovalent hydrocarbon radical which has 1 to 20 carbon atoms and optionally has at least one carboxylic ester, nitrile, nitro, phosphonic ester, sulfone or sulfonic ester group,
   or is a substituent of the formula (VIIa)

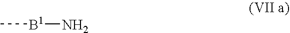

and
A¹, Z¹, Z², Z³ and Z⁴, B¹ and R⁸ are each as already defined.

The reaction between at least one amine B1 of the formula (VII) and at least one aldehyde ALD of the formula (VIIIa) or (VIIIb) is effected in a condensation reaction with elimination of water. Such condensation reactions are very well known and described, for example in Houben-Weyl, “Methoden der organischen Chemie” [Methods of Organic Chemistry], Vol. XI/2, page 73ff. The aldehyde ALD is used here stoichiometrically or in a stoichiometric excess in relation to the primary amino groups of the amine B1. Typically, such condensation reactions are performed in the presence of a solvent, by means of which the water formed in the reaction is removed azeotropically.

Suitable aldehydes ALD are firstly aldehydes of the formula (VIIIa), for example propanal, 2-methylpropanal, butanal, 2-methylbutanal, 2-ethylbutanal, pentanal, 2-methylpentanal, 3-methylpentanal, 4-methylpentanal, 2,3-dimethylpentanal, hexanal, 2-ethylhexanal, heptanal, octanal, nonanal, decanal, undecanal, 2-methylundecanal, dodecanal, methoxyacetaldehyde, cyclopropanecarboxaldehyde, cyclopentanecarboxaldehyde, cyclohexane-carboxaldehyde and diphenylacetaldehyde.

Suitable aldehydes ALD are secondly aldehydes of the formula (VIIIb), for example aromatic aldehydes such as benzaldehyde, 2- and 3- and 4-tolualdehyde, 4-ethyl- and 4-propyl- and 4-isopropyl- and 4-butylbenzaldehyde, 2,4-dimethylbenzaldehyde, 2,4,5-trimethylbenzaldehyde, 4-acetoxybenzaldehyde, 4-anisaldehyde, 4-ethoxybenzaldehyde, the isomeric di- and trialkoxybenzaldehydes, 2-, 3- and 4-nitrobenzaldehyde, 2-, 3- and 4-formylpyridine, 2-furfuraldehyde, 2-thiophenecarbaldehyde, 1- and 2-naphthyl-aldehyde, 3- and 4-phenyloxybenzaldehyde; quinoline-2-carbaldehyde and the 3, 4, 5, 6, 7 and 8 positional isomers thereof, and anthracene-9-carbaldehyde; and glyoxal, glyoxalic esters, for example methyl glyoxalate, cinnamaldehyde and substituted cinnamaldehydes.

Especially suitable aldehydes ALD are aldehydes which are not enolizable, especially those which do not have a hydrogen atom in the a position to the carbonyl group.

Examples of especially suitable aldehydes ALD are the aldehydes of the formula (VIIIb) mentioned.

Especially suitable aldehydes ALD are additionally the so-called tertiary aldehydes, i.e. aldehydes ALD of the formula (VIIIa) which do not have a hydrogen atom in the a position to the carbonyl group. Tertiary aldehydes

ALD of the formula (VIIIa) are aldehydes ALD of the formula (IX).

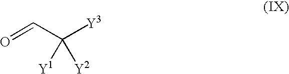

In formula (IX), Y¹, Y² and Y³ are each as already defined.

Suitable aldehydes ALD of the formula (IX) are, for example, pivalaldehyde (=2,2-dimethylpropanal), 2,2-dimethylbutanal, 2,2-diethylbutanal, 1-methylcyclopentanecarboxaldehyde, 1-methylcyclohexanecarboxaldehyde; ethers formed from 2-hydroxy-2-methylpropanal and alcohols such as propanol, isopropanol, butanol and 2-ethylhexanol; esters of 2-formyl-2-methylpropionic acid or 3-formyl-3-methylbutyric acid and alcohols such as propanol, isopropanol, butanol and 2-ethylhexanol; esters of 2-hydroxy-2-methylpropanal and carboxylic acids such as butyric acid, isobutyric acid and 2-ethylhexanoic acid; and the ethers and esters, described below as particularly suitable, of 2,2-disubstituted 3-hydroxypropanals, -butanals or analogous higher aldehydes, especially of 2,2-dimethyl-3-hydroxypropanal.

Further suitable aldehydes ALD of the formula (IX) are aldehydes ALD of the formula (X).

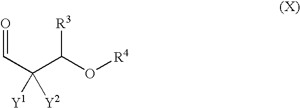

In formula (X), Y¹, Y², R³ and R⁴ are each as already defined.

Preferably, in formula (X), Y¹ and Y² are each a methyl group and R³ is a hydrogen atom.

In one embodiment, a suitable aldehyde ALD of the formula (X) is an aldehyde ALD1 of the formula (Xa)

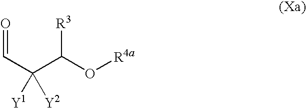

where R^{4a} is a hydrocarbon radical having 1 to 30 carbon atoms, especially 11 to 30 carbon atoms, which optionally contains ether oxygen atoms.

The aldehydes ALD1 of the formula (Xa) are ethers of aliphatic, cycloaliphatic or arylaliphatic 2,2-disubstituted 3-hydroxyaldehydes with alcohols or phenols of the formula R^{4a}—OH, for example fatty alcohols or phenols. Suitable 2,2-disubstituted 3-hydroxyaldehydes are in turn obtainable from aldol reactions, especially crossed aldol reactions, between primary or secondary aliphatic aldehydes, especially formaldehyde, and secondary aliphatic, secondary cycloaliphatic or secondary arylaliphatic aldehydes, for example isobutyraldehyde, 2-methylbutyraldehyde, 2-ethylbutyraldehyde, 2-methylvaleraldehyde, 2-ethylcapronaldehyde, cyclopentanecarboxaldehyde, cyclohexanecarboxaidehyde, 1,2,3,6-tetrahydrobenzaldehyde, 2-methyl-3-phenylpropionaldehyde, 2-phenylpropionaldehyde (hydratropaldehyde) or diphenylacetaldehyde. Examples of suitable 2,2-disubstituted 3-hydroxy-aldehydes are 2,2-dimethyl-3-hydroxypropanal, 2-hydroxymethyl-2-methyl-butanal, 2-hydroxymethyl-2-ethylbutanal, 2-hydroxymethyl-2-methylpentanal, 2-hydroxymethyl-2-ethylhexanal, 1-hydroxymethylcyclopentanecarboxaldehyde, 1-hydroxymethylcyclohexanecarboxaldehyde, 1-hydroxymethylcyclohex-3-enecarboxaldehyde, 2-hydroxymethyl-2-methyl-3-phenylpropanal, 3-hydroxy-2-methyl-2-phenylpropanal and 3-hydroxy-2,2-diphenylpropanal.

Examples of such aldehydes ALD1 of the formula (Xa) mentioned are 2,2-dimethyl-3-phenoxypropanal, 3-cyclohexyloxy-2,2-dimethylpropanal, 2,2-dimethyl-3-(2-ethylhexyloxy)propanal, 2,2-dimethyl-3-lauroxypropanal and 2,2-dimethyl-3-stearoxypropanal.

In a further embodiment, a suitable aldehyde ALD of the formula (X) is an aldehyde ALD2 of the formula (Xb)

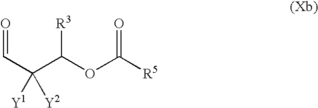

where R⁵ is a hydrogen atom or a hydrocarbon radical having 1 to 5 carbon atoms.

The aldehydes ALD2 of the formula (Xb) are esters of the 2,2-disubstituted 3-hydroxyaldehydes already described, for example 2,2-dimethyl-3-hydroxypropanal, 2-hydroxymethyl-2-methylbutanal, 2-hydroxymethyl-2-ethylbutanal, 2-hydroxymethyl-2-methylpentanal, 2-hydroxymethyl-2-ethylhexanal, 1-hydroxymethylcyclopentanecarboxaldehyde, 1-hydroxy-methylcyclohexanecarboxaldehyde, 1-hydroxymethylcyclohex-3-enecarbox-aldehyde, 2-hydroxymethyl-2-methyl-3-phenylpropanal, 3-hydroxy-2-methyl-2-phenylpropanal and 3-hydroxy-2,2-diphenylpropanal, with carboxylic acids such as formic acid, acetic acid, propionic acid, butyric acid, isobutyric acid, valeric acid and caproic acid.

Examples of such aldehydes ALD2 of the formula (Xb) mentioned are 2,2-dimethyl-3-formyloxypropanal, 3-acetoxy-2,2-dimethylpropanal, 2,2-dimethyl-3-propionoxypropanal, 3-butyroxy-2,2-dimethylpropanal, 2,2-dimethyl-3-isobutyroxypropanal, 2,2-dimethyl-3-pentoyloxypropanal and 2,2-dimethyl-3-hexoyloxypropanal.

Preferred aldehydes ALD are the aldehydes ALD of the formula (VIIIb) and of the formula (IX).

Especially preferred are the aldehydes ALD of the formula (X).

Most preferred are the aldehydes ALD2 of the formula (Xb), especially 3-acetoxy-2,2-dimethylpropanal.

To prepare a compound VB1 of the formula (IIIa) or (IIIb) having aldimino groups, in addition to at least one aldehyde ALD of the formula (VIIIa) or (VIIIb), it is additionally possible to use, for example, at least one amine B1 of the formula (VII).

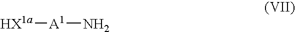

An amine B1 of the formula (VII) contains one or two aliphatic primary amino groups and at least one reactive group which has an active hydrogen.

In one embodiment, suitable amines B1 of the formula (VII) are compounds with one or two primary aliphatic amino groups and one secondary amino group, for example N-methyl-1,2-ethanediamine, N-ethyl-1,2-ethanediamine, N-butyl-1,2-ethanediamine, N-hexyl-1,2-ethanediamine, N-(2-ethylhexyl)-1,2-ethanediamine, N-cyclohexyl-1,2-ethanediamine, 4-amino-methylpiperidine, 3-(4-aminobutyl)piperidine, N-(2-aminoethyl)piperazine, diethylenetriamine (DETA), bishexamethylenetriamine (BHMT), 3-(2-aminoethyl)aminopropylamine; di- and triamines from the cyanoethylation or cyanobutylation of primary mono- and diamines, for example N-methyl-1,3-propanediamine, N-ethyl-1,3-propanediamine, N-butyl-1,3-propanediamine, N-hexyl-1,3-propanediamine, N-(2-ethylhexyl)-1,3-propanediamine, N-dodecyl-1,3-propanediamine, N-cyclohexyl-1,3-propanediamine, 3-methylamino-1-pentylamine, 3-ethylamino-1-pentylamine, 3-butylamino-1-pentylamine, 3-hexylamino-1-pentylamine, 3-(2-ethylhexyl)amino-1-pentylamine, 3-dodecyl-amino-1-pentylamine, 3-cyclohexylamino-1-pentylamine, dipropylenetriamine (DPTA), N3-(3-aminopentyl)-1,3-pentanediamine, N5-(3-aminopropyl)-2-methyl-1,5-pentanediamine, N5-(3-amino-1-ethylpropyl)-2-methyl-1,5-pentanediamine, and fatty diamines such as N-cocoalkyl-1,3-propanediamine, N-oleyl-1,3-propanediamine, N-soyaalkyl-1,3-propanediamine, N-tallowalkyl-1,3-propanediamine or N-(C₁₆₋₂₂-alkyl)-1,3-propanediamine, as obtainable, for example, under the trade name Duomeen® from Akzo Nobel; the products from the Michael-like addition of aliphatic primary di- or triamines with acrylonitrile, maleic or fumaric diesters, citraconic diesters, acrylic and methacrylic esters, acryl- and methacrylamides and itaconic diesters, reacted in a molar ratio of 1:1.

In a further embodiment, suitable amines B1 of the formula (VII) are aliphatic hydroxyamines with a primary amino group, for example 2-aminoethanol, 2-methylaminoethanol, 1-amino-2-propanol, 3-amino-1-propanol, 4-amino-1-butanol, 4-amino-2-butanol, 2-amino-2-methylpropanol, 5-amino-1-pentanol, 6-amino-1-hexanol, 7-amino-1-heptanol, 8-amino-1-octanol, 10-amino-1-decanol, 12-amino-1-dodecanol, 4-(2-aminoethyl)-2-hydroxyethylbenzene, 3-aminomethyl-3,5,5-trimethylcyclohexanol; derivatives bearing one primary amino group of glycols such as diethylene glycol, dipropylene glycol, dibutylene glycol and higher oligomers and polymers of these glycols, for example 2-(2-aminoethoxy)ethanol, triethylene glycol monoamine, α-(2-hydroxymethylethyl)-ω-(2-aminomethylethoxy)poly(oxy(methyl-1,2-ethanediyl)); derivatives bearing one hydroxyl group and one primary amino group of polyalkoxylated trihydric or higher polyhydric alcohols; products from the single cyanoethylation and subsequent hydrogenation of glycols, for example 3-(2-hydroxyethoxy)propylamine, 3-(2-(2-hydroxyethoxy)ethoxy)-propylamine and 3-(6-hydroxyhexyloxy)propylamine.

In a further embodiment, suitable amines B1 of the formula (VII) are aliphatic mercaptoamines with a primary amino group, for example 2-amino-ethanethiol (cysteamine), 3-aminopropanethiol, 4-amino-1-butanethiol, 6-amino-1-hexanethiol, 8-amino-1-octanethiol, 10-amino-1-decanethiol, 12-amino-1-dodecanethiol, and amino thiosugars such as 2-amino-2-deoxy-6-thioglucose.

Preferred amines B1 of the formula (VII) are amines selected from the group consisting of N-methyl-1,2-ethanediamine, N-ethyl-1,2-ethanediamine, N-cyclohexyl-1,2-ethanediamine, N-methyl-1,3-propanediamine, N-ethyl-1,3-propanediamine, N-butyl-1,3-propanediamine, N-cyclohexyl-1,3-propanediamine, 4-aminomethylpiperidine, 3-(4-aminobutyl)piperidine, DETA, DPTA, BHMT, and fatty diamines such as N-cocoalkyl-1,3-propanediamine, N-oleyl-1,3-propanediamine, N-soyaalkyl-1,3-propanediamine and N-tallowalkyl-1,3-propanediamine; products from the Michael-type addition of aliphatic primary diamines with maleic and fumaric diesters, acrylic and methacrylic esters, acryl- and methacrylamides, preferably with maleic diesters, especially dimethyl, diethyl, dipropyl and dibutyl maleate, and with acrylic esters, especially methyl acrylate, reacted in a molar ratio of 1:1; aliphatic hydroxy- or mercaptoamines in which the primary amino group is separated from the hydroxyl or mercapto group by a chain of at least 5 atoms, or by a ring, especially 5-amino-1-pentanol, 6-amino-1-hexanol and higher homologs thereof, 4-(2-aminoethyl)-2-hydroxyethylbenzene, 3-aminomethyl-3,5,5-tri-methylcyclohexanol, 2-(2-aminoethoxy)ethanol, triethylene glycol monoamine and higher oligomers and polymers thereof, 3-(2-hydroxyethoxy)propylamine, 3-(2-(2-hydroxyethoxy)ethoxy)propylamine and 3-(6-hydroxyhexyloxy)propyl-amine.

The reaction between an aldehyde ALD and an amine B1 leads to hydroxyaldimines when the amine B1 used is a hydroxyamine; to mercaptoaldimines when the amine B1 used is a mercaptoamine; or to aminoaldimines when the amine B1 used is an amine which, as well as one or two primary amino groups, bears a secondary amino group.

In one embodiment of the compound VB1 of the formula (IIIa) having aldimino groups, X¹ is N—R⁷. Such compounds VB1 of the formula (IIIa) or (IIIb) can in some cases be prepared by a slightly different route than that described so far. This synthesis route consists in reacting an aldehyde ALD of the formula (VIIIa) or (VIIIb) with a difunctional aliphatic primary amine C of the formula H₂N-A′-NH₂—where A′ is a divalent hydrocarbon radical which has 2 to 20 carbon atoms and optionally has heteroatoms—in a first step to give an intermediate which, as well as an aldimino group, also comprises a primary amino group. This intermediate is subsequently converted in a second step to a compound VB1 of the formula (IIIa) or (IIIb) having aldimino groups, by simply alkylating the primary amino group. For the alkylation, especially compounds having exactly one activated double bond which can enter into Michael-type addition reactions with primary amines are used; such compounds are referred to hereinafter as the “Michael acceptor”.

The reaction of an aldehyde ALD with an amine C to give the intermediate having a primary amino group is effected in a condensation reaction with elimination of water, as described further up for the reaction of at least one aldehyde ALD with at least one amine B1 of the formula (VII). The stoichiometry between the aldehyde ALD and the amine C is selected such that 1 mol of aldehyde ALD is used per 1 mol of amine C which contains two primary amino groups. Preference is given to a solvent-free preparation process wherein the water formed in the condensation is removed from the reaction mixture by means of application of reduced pressure.

The reaction of the intermediate having a primary amino group with the Michael acceptor is effected, for example, by mixing the intermediate with a stoichiometric or slightly superstoichiometric amount of the Michael acceptor and heating the mixture at temperatures of 20° C. to 110° C. until complete conversion of the intermediate to the compound VB1 of the formula (IIIa) or (Illb). The reaction is effected preferably without the use of solvents.

Examples of suitable amines C for this reaction are aliphatic diamines such as ethylenediamine, 1,2- and 1,3-propanediamine, 2-methyl-1,2-propane-diamine, 2,2-dimethyl-1,3-propanediamine, 1,3- and 1,4-butanediamine, 1,3- and 1,5-pentanediamine, 2-butyl-2-ethyl-1,5-pentanediamine, 1,6-hexamethylenediamine (HMDA), 2,2,4- and 2,4,4-trimethylhexamethylene-diamine and mixtures thereof (TMD), 1,7-heptanediamine, 1,8-octanediamine, 2,4-dimethyl-1,8-octanediamine, 4-aminomethyl-1,8-octanediamine, 1,9-nonanediamine, 2-methyl-1,9-nonanediamine, 5-methyl-1,9-nonanediamine, 1,10-decanediamine, isodecanediamine, 1,11-undecanediamine, 1,12-dodecanediamine, methylbis(3-aminopropyl)amine, 1,5-diamino-2-methyl-pentane (MPMD), 1,3-diaminopentane (DAMP), 2,5-dimethyl-1,6-hexamethy-lenediamine; cycloaliphatic diamines such as 1,2-, 1,3- and 1,4-diaminocyclo-hexane, bis(4-aminocyclohexyl)methane (H₁₂MDA), bis(4-amino-3-methyl-cyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane (M-MECA), 1-amino-3-aminomethyl-3,5,5-trimethylcyclohexane (=isophorone-diamine or IPDA), 2- and 4-methyl-1,3-diaminocyclohexane and mixtures thereof, 1,3- and 1,4-bis(aminomethyl)cyclohexane, 1-cyclohexylamino-3-aminopropane, 2,5(2,6)bis(aminomethyl)bicyclo[2.2.1]heptane (NBDA, produced by Mitsui Chemicals), 3(4),8(9)bis(aminomethyl)-tricyclo-[5.2.1.0^{2,6}]decane, 1,4-diamino-2,2,6-trimethylcyclohexane (TMCDA), 3,9-bis(3-aminopropyl)-2,4,8,10-tetraoxaspiro[5.5]undecane; arylaliphatic diamines such as 1,3-xylylenediamine (MXDA), 1,4-xylylenediamine (PXDA); aliphatic diamines containing ether groups, such as bis(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine and higher oligomers of these diamines, and also polyoxyalkylenediamines.

The latter are typically products from the amination of polyoxyalkylenediols and are, for example, obtainable under the name Jeffamine® (from Huntsman Chemicals), under the name Polyetheramin (from BASF) or under the name PC Amine® (from Nitroil). Especially suitable polyoxyalkylenediamines are Jeffamine® D-230, Jeffamine® D-400, Jeffamine® XTJ-511, Jeffamine® XTJ-568 and Jeffamine® XTJ-569; Polyetheramin D 230 and Polyetheramin D 400; PC Amine® DA 250 and PC Amine® DA 400.

Preferred amines C are diamines in which the primary amino groups are separated by a chain of at least five atoms, or by a ring, especially 1,5-diamino-2-methylpentane, 1,6-hexamethylenediamine, 2,2,4- and 2,4,4-tri-methylhexamethylenediamine and mixtures thereof, 1,10-decanediamine, 1,12-dodecanediamine, 1,3- and 1,4-diaminocyclohexane, bis(4-aminocyclo-hexyl)methane, bis(4-amino-3-methylcyclohexyl)methane, 1-amino-3-amino-methyl-3,5,5-trimethylcyclohexane, 1,3- and 1,4-bis(aminomethyl)cyclohexane, 2,5(2,6)bis(aminomethyl)bicyclo[2.2.1]heptane, 3(4),8(9)bis(aminomethyl)tri-cyclo[5.2.1.0^{2,6}]decane, 1,4-diamino-2,2,6-trimethylcyclohexane (TMCDA), 3,9-bis(3-aminopropyI)-2,4,8,10-tetraoxaspiro[5.5]undecane, 1,3- and 1,4-xylylene-diamine, and also the aliphatic diamines and polyoxyalkylenediamines containing ether groups mentioned.

Examples of suitable Michael acceptors for this reaction are maleic or fumaric diesters such as dimethyl maleate, diethyl maleate, dibutyl maleate, diethyl fumarate; citraconic diesters such as dimethyl citraconate; acrylic or methacryiic esters such as methyl (meth)acrylate, ethyl (meth)acrylate, butyl (meth)acrylate, lauryl (meth)acrylate, stearyl (meth)acrylate, tetrahydrofuryl (meth)acrylate, isobornyl (meth)acrylate; itaconic diesters such as dimethyl itaconate; cinnamic esters such as methyl cinnamate; vinylphosphonic diesters such as dimethyl vinylphosphonate; vinylsulfonic esters, especially aryl vinylsulfonate; vinyl sulfones; vinyl nitriles such as acrylonitrile, 2-pentenenitrile or fumaronitrile; 1-nitroethylenes such as β-nitrostyrene; and Knoevenagel condensation products, for example those formed from malonic diesters and aldehydes such as formaldehyde, acetaldehyde or benzaldehyde. Preference is given to maleic diesters, acrylic esters, phosphonic diesters and vinyl nitriles.

In a further embodiment, suitable compounds VB are compounds which have both a group bearing an active hydrogen and at least one ketimino group. Such compounds VB are especially compounds VB2 which have ketimino groups and are of the formula (XI)

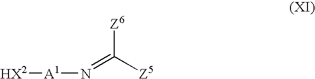

where
X² is O or S or N—R¹⁰ or N—R⁸,
   where R¹⁰
   is a monovalent hydrocarbon radical which has 1 to 20 carbon atoms and optionally has at least one carboxylic ester, nitrile, nitro, phosphonic ester, sulfone or sulfonic ester group,
   or is a substituent of the formula (XII);

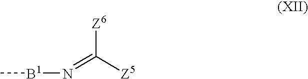

Z⁵ and Z⁶
   are each independently a monovalent hydrocarbon radical having 1 to 12 carbon atoms,
   or
   together are a divalent hydrocarbon radical which has 4 to 20 carbon atoms and is part of an optionally substituted carbocyclic ring having 5 to 8, preferably 6, carbon atoms; and
A¹, B¹ and R⁸ are each as already defined.
   In the compounds VB2 of the formula (XI), Z⁵ and Z⁶ are preferably each independently an unbranched or especially branched alkyl radical having 1 to 6 carbon atoms, or together are an alkyl radical which has 4 to 10 carbon atoms and is part of an optionally substituted carbocyclic ring having 5 or 6 and especially 6 carbon atoms, and/or X² is preferably O or N—R¹⁰ or N—R⁸.

A compound VB2 which has ketimino groups and is of the formula (XI) is, for example, obtainable from the reaction of at least one amine B1 of the formula (VII) with at least one ketone of the formula (XIII) with elimination of water, the keto groups being used stoichiometrically or in a stoichiometric excess in relation to the primary amino groups.

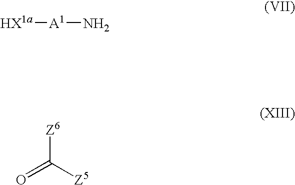

In formula (XIII), Z⁵ and Z⁶ are each as already defined.

For this reaction, the same amines B1 of the formula (VII) as have already been mentioned previously for the preparation of compounds VB1 which have aldimino groups and are of the formula (IIIa) or (IIIb) are suitable.

Ketones of the formula (XIII) suitable for this reaction are, for example, acetone, methyl ethyl ketone, methyl propyl ketone, methyl isopropyl ketone, methyl isobutyl ketone, methyl pentyl ketone, methyl isopentyl ketone, diethyl ketone, dipropyl ketone, diisopropyl ketone, dibutyl ketone, diisobutyl ketone, cyclopentanone, cyclohexanone and acetophenone.

In one embodiment of the compound VB2 which has ketimino groups and is of the formula (XI), X² is N—R¹⁰. Such compounds VB2 of the formula (XI) can in some cases be prepared by a slightly different route than that described so far, by reacting at least one ketone of the formula (XIII) with at least one difunctional aliphatic primary amine C of the formula H₂N-A′-NH₂—where A′ is a divalent hydrocarbon radical which has 2 to 20 carbon atoms and optionally has heteroatoms—in a first step to give an intermediate which, as well as a ketimino group, also contains a primary amino group. This intermediate is subsequently reacted in a second step in an addition reaction with a Michael acceptor having a double bond, the double bonds being used stoichiometrically in relation to the primary amino groups of the intermediate. This forms at least one amino ketimine which, as well as a ketimino group, also contains a secondary amino group, i.e. a compound VB2 of the formula (XI).

The reaction of a ketone of the formula (XIII) with an amine C to give the intermediate having a primary amino group is effected in the same way as already described for the reaction of an aldehyde ALD with an amine C, and likewise the reaction of the intermediate with the Michael acceptor.

In a further embodiment, suitable compounds VB are compounds which have both a group bearing an active hydrogen and at least one enamino group. Such compounds VB are especially compounds VB3 which have enamino groups and are of the formula (XIV),

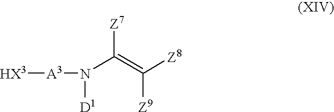

where
A³
   is a divalent hydrocarbon radical which has 2 to 20 carbon atoms and optionally has heteroatoms,
   or
   together with D¹ or together with R¹² is a trivalent hydrocarbon radical which has 3 to 20 carbon atoms and optionally contains at least one heteroatom, especially in the form of ether oxygen or tertiary amine nitrogen,
X³ is O or S or N—R¹¹ or N—R¹²,
   where R¹¹
   is a monovalent hydrocarbon radical which has 1 to 20 carbon atoms and optionally has at least one carboxylic ester, nitrile, nitro, phosphonic ester, sulfone or sulfonic ester group,
   or is a substituent of the formula (XV)

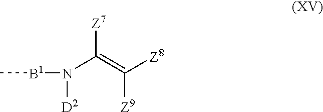

where D² is a monovalent hydrocarbon radical having 1 to 12 carbon atoms,
   and R¹², either together with A³ or together with D¹, is a trivalent hydrocarbon radical which has 3 to 20 carbon atoms and optionally contains at least one heteroatom, especially in the form of ether oxygen or tertiary amine nitrogen;
Z⁷ and Z⁸
   are each independently a hydrogen atom or a monovalent hydrocarbon radical having 1 to 12 carbon atoms, or
   together are a divalent hydrocarbon radical which has 3 to 20 carbon atoms and is part of an optionally substituted carbocyclic ring having 5 to 8, preferably 6, carbon atoms;
Z⁹ is a hydrogen atom or a monovalent hydrocarbon radical having 1 to 12 carbon atoms; and
D¹
   is a monovalent hydrocarbon radical having 1 to 12 carbon atoms,
   or
   together with R¹² or together with A³ is a trivalent hydrocarbon radical which has 4 to 20 carbon atoms and optionally contains at least one heteroatom, especially in the form of ether oxygen or tertiary amine nitrogen; and
B¹ is as already defined.

Preferably, Z⁷, Z⁸ and Z⁹ are each independently either a hydrogen atom or an alkyl radical having 1 to 4 carbon atoms.

Additionally preferably, Z⁷ and Z⁸ together are a divalent hydrocarbon radical which has 3 to 10 carbon atoms and is part of an optionally substituted carbocyclic ring having 5 to 8 and preferably 6 carbon atoms.

Additionally preferably, D¹ and D² are each independently a monovalent hydrocarbon radical having 1 to 6 carbon atoms.

Additionally preferably, D¹ together with R¹² is an optionally substituted ethylene radical.

Additionally preferably, D¹ together with A³ is a trivalent hydrocarbon radical which has 4 to 10 carbon atoms and optionally contains at least one heteroatom, especially in the form of ether oxygen or tertiary amine nitrogen.

A compound VB3 which has enamino groups and is of the formula (XIV) is, for example, obtainable from the reaction of at least one amine B3 of the formula (XVI) with at least one aliphatic or cycloaliphatic aldehyde or ketone of the formula (XVII) which has at least one C-H moiety in an a position to the carbonyl group, with elimination of water.

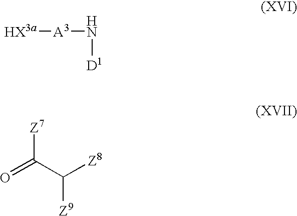

In these structures,
X^{aa} is O or N—R¹³ or N—R¹²,
   where R¹³
   is a monovalent hydrocarbon radical which has 1 to 20 carbon atoms and optionally has at least one carboxylic ester, nitrile, nitro, phosphonic ester, sulfone or sulfonic ester group,
   or is a substituent of the formula (XVIII)

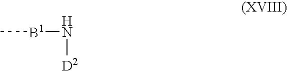

In one embodiment, suitable amines B3 of the formula (XVI) are polyamines with two secondary amino groups, for example piperazine, 4,4′-dipiperidylpropane, N,N′-dimethylhexamethylenediamine and homologs with higher alkyl or cycloalkyl groups instead of the methyl groups, and also polyamines with three secondary amino groups, for example N,N′-dimethyldiethylenetriamine, such amines B3 being reacted with an aldimine or ketimine of the formula (XVII) such that one of the secondary amino groups is not converted such that an active hydrogen is preserved as an HX³ group.

In a further embodiment, suitable amines B3 of the formula (XVI) are amines having a hydroxyl group and a secondary amino group, for example N-(2-hydroxyethyl)piperazine, 4-hydroxypiperidine and monoalkoxylated primary monoamines, i.e. reaction products of primary monoamines, for example methylamine, ethylamine, propylamine, propylamine, butylamine, hexylamine, 2-ethylhexylamine, benzylamine and fatty amines such as laurylamine or stearylamine, with epoxides such as ethylene oxide, propylene oxide or butylene oxide, in a stoichiometric ratio of 1:1, for example N-methylethanolamine, N-ethylethanolamine, N-butylethanolamine and N-butylisopropanolamine.

In a further embodiment, suitable amines B3 of the formula (XVI) are amines having a mercapto group and a secondary amino group, for example N-(2-mercaptoethyl)piperazine, 4-mercaptopiperidine and 2-mercaptoethyl-butylamine.

Suitable aldehydes or ketones of the formula (XVII) are aldehydes, for example propanal, 2-methylpropanal, butanal, 2-methylbutanal, 2-ethylbutanal, pentanal, 2-methylpentanal, 3-methylpentanal, 4-methylpentanal, 2,3-dimethylpentanal, hexanal, 2-ethylhexanal, heptanal, octanal, nonanal, decanal, undecanal, 2-methylundecanal, dodecanal, methoxyacetaldehyde, cyclopropanecarboxaldehyde, cyclopentanecarboxaldehyde, cyclohexane-carboxaldehyde and diphenylacetaldehyde; and ketones, especially cyclic ketones, for example cyclopentanone and cyclohexanone.

In a further embodiment, suitable compounds VB are compounds which have both a group bearing active hydrogen and at least one oxazolidino group. Such compounds VB are especially compounds VB4 which have oxazolidino groups and are of the formula (XIX)

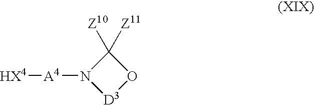

where
A⁴ is a divalent hydrocarbon radical which has 2 to 20 carbon atoms and optionally has heteroatoms;
Z¹⁰ and Z¹¹ are each independently a hydrogen atom or a monovalent hydrocarbon radical having 1 to 12 carbon atoms,
D³ is an optionally substituted alkylene radical having 2 or 3 carbon atoms, and
X⁴ is O or S or N—R¹⁴
   where R¹⁴
   is a monovalent hydrocarbon radical which has 1 to 20 carbon atoms and optionally has at least one carboxylic ester, nitrile, nitro, phosphonic ester, sulfone or sulfonic ester group,
   or is a substituent of the formula (XX)

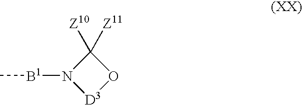

and B¹ is as already defined.

Preferably, Z¹⁰ is a hydrogen atom and Z¹¹ is an alkyl radical having 1 to 8 carbon atoms.

Additionally preferably, A⁴ is an optionally substituted alkylene radical having 2 or 3 carbon atoms.

Additionally preferably, X⁴ is O.

In the present document, “oxazolidino group” refers to both tetrahydrooxazole groups (5-membered ring) and tetrahydrooxazine groups (6-membered ring).

A compound VB4 which has oxazolidino groups and is of the formula (XIX) is, for example, obtainable from the reaction of at least one amine B4 of the formula (XXI) with at least one aldehyde or ketone of the formula (XXII) with elimination of water.

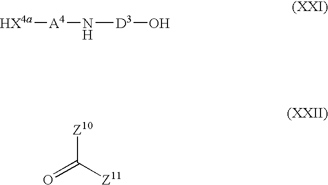

In these structures,
X^{4a} is O or S or N—R¹⁵,
   where R¹⁵
   is a monovalent hydrocarbon radical which has 1 to 20 carbon atoms and optionally has at least one carboxylic ester, nitrile, nitro, phosphonic ester, sulfone or sulfonic ester group,
   or is a substituent of the formula (XXIII)

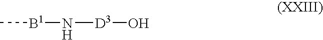

and A⁴, D³, Z¹⁰, Z¹¹ and B¹ are each as already defined.

Suitable amines B4 of the formula (XXI) are secondary hydroxylamines, for example diethanolamine, dipropanolamine and diisopropanolamine.

A preferred amine B4 is diethanolamine, which can be reacted with a ketone or aldehyde of the formula (XXII) with elimination of water to give a compound VB4′ which has oxazolidino groups and is of the formula (XIXa).

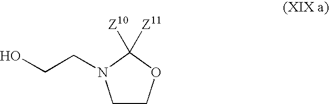

Suitable aldehydes or ketones of the formula (XXII) are ketones, for example acetone, methyl ethyl ketone, methyl propyl ketone, methyl isopropyl ketone, methyl isobutyl ketone, methyl pentyl ketone, methyl isopentyl ketone, diethyl ketone, dipropyl ketone, diisopropyl ketone, dibutyl ketone, diisobutyl ketone, cyclopentanone, cyclohexanone. Especially suitable are aldehydes, for example propanal, 2-methylpropanal, butanal, 2-methylbutanal, 2-ethylbutanal, pentanal, 2-methylpentanal, 3-methylpentanal, 4-methylpentanal, 2,3-dimethylpentanal, hexanal, 2-ethyihexanal, heptanal, octanal, nonanal, decanal, undecanal, 2-methylundecanal, dodecanal, methoxyacetaldehyde, cyclopropanecarboxaldehyde, cyclopentanecarboxaldehyde, cyclohexane-carboxaldehyde, diphenylacetaldehyde, benzaldehyde and substituted benzaldehydes. Preference is given to 2-methylpropanal.

In a further embodiment, suitable compounds VB are compounds with mixed capped amino groups. These are compounds which bear both a group bearing an active hydrogen and two different capped amino groups which are selected from the group consisting of ketimino groups, enamino groups, oxazolidino groups and aldimino groups of the formula (Ia) or (Ib). Such compounds VB with mixed capped amino groups typically contain a secondary amino group which, as well as the active hydrogen, bears two radicals with one different capped amino group each.

Compounds VB with mixed capped amino groups are, for example, the following:

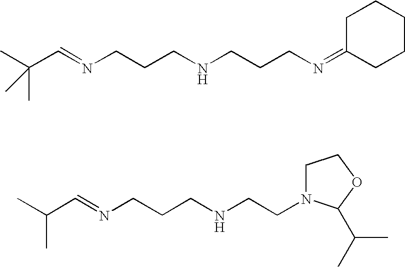

The compounds VB have the property that they are monofunctional with respect to isocyanate groups with exclusion of moisture, which means that they bear only one reactive group which can react directly with isocyanate groups. This reactive group bearing the active hydrogen reacts with an isocyanate group to give a urethane group, thiourethane group or urea group. The capped amino groups in the form of aldimino groups, ketimino groups, enamino groups and/or oxazolidino groups of the compounds VB react with isocyanate groups only exceptionally slowly, if at all, with exclusion of moisture.

The compounds VB1 of the formula (IIIa) or (IIIb) have one or two aldimino groups of the formula (Ia) or (Ib). On ingress of moisture, or water, these aldimino groups can hydrolyze to amino groups in a formal sense via intermediates, which releases an aldehyde ALD of the formula (VIIa) or (VIIb). Since this hydrolysis reaction is reversible and the chemical equilibrium is clearly on the aldimine side, it can be assumed that, in the absence of groups reactive toward amines, only some of the aldimino groups are hydrolyzed. In the presence of isocyanate groups, the hydrolysis equilibrium shifts, since the aldimino groups being hydrolyzed react irreversibly with the isocyanate groups to give urea groups. The reaction of the isocyanate groups with the aldimino groups being hydrolyzed need not necessarily proceed via free amino groups. It will be appreciated that reactions with intermediates of the hydrolysis reaction are also possible. For example, it is conceivable that an aldimino group being hydrolyzed reacts directly with an isocyanate group in the form of a hemiaminal. With exclusion of moisture, aldimino groups have very good storage stability together with isocyanate groups.

The compounds VB1 of the formula (IIIb) and of the formula (V) which are prepared proceeding from nonenolizable aldehydes ALD additionally have the property that their aldimino groups cannot tautomerize to enamino groups. Owing to this property, their aldimino groups also have very good storage stability together with the very reactive aromatic isocyanate groups.

The compounds VB2 of the formula (XI) have one or two ketimino groups. On ingress of moisture, these ketimino groups are hydrolyzed to amino groups, which releases a ketone of the formula (XIII). In the presence of isocyanate groups, the ketimino groups being hydrolyzed react with the isocyanate groups to form urea groups. With exclusion of moisture, ketimino groups are storage-stable for a certain time together with isocyanate groups, especially aliphatic isocyanate groups.

The compounds VB3 of the formula (XIV) have one or two enamino groups. On ingress of moisture, these enamino groups are hydrolyzed to secondary amino groups, which releases an aldehyde or a ketone of the formula (XVII). In the presence of isocyanate groups, the enamino groups being hydrolyzed react with the isocyanate groups to give urea groups. With exclusion of moisture, enamino groups are storage-stable for a certain time together with isocyanate groups, especially aliphatic isocyanate groups.

The compounds VB4 of the formula (XIX) have one or two oxazolidino groups. On ingress of moisture, these oxazolidino groups are hydrolyzed, which releases both a secondary amino group and a hydroxyl group per oxazolidino group being hydrolyzed, and which releases an aldehyde or a ketone of the formula (XXII). In the presence of isocyanate groups, the secondary amino groups react to give urea groups, and the hydroxyl groups to give urethane groups. When they are hydrolyzed, capped amino groups in the form of oxazolidino groups are thus difunctional with respect to isocyanate groups, in contrast to capped amino groups in the form of aldimino, ketimino and enamino groups. With exclusion of moisture, oxazolidino groups have very good storage stability together with isocyanate groups, especially aliphatic isocyanate groups.

In the present process for preparing a polyurethane composition with a low isocyanate monomer content, at least one polyurethane polymer PUP having isocyanate groups is reacted with at least one compound VB.

In this reaction, the ratio between the isocyanate groups of the polyurethane polymer PUP and the sum of the capped amino groups and the group of the compound VB which bears an active hydrogen has a value of ≧1. When the capped amino groups present are oxazolidino groups, they are advantageously counted double, since they behave difunctionally with respect to isocyanates after the hydrolysis. Advantageously, in this case, the ratio between the isocyanate groups of the polyurethane polymer PUP and the sum of twice the number of oxazolidino groups and the number of any other capped amino groups present and the number of groups of the compound VB bearing an active hydrogen thus has a value of ≧1.

In this reaction, the reactive group of the compound VB which bears the active hydrogen reacts in each case with an isocyanate group to form, as the reaction product, at least one polyurethane polymer having capped amino groups and isocyanate groups. The reaction is performed with exclusion of moisture, such that the capped amino groups do not react with further isocyanate groups present at first. The reaction is suitably performed at a temperature at which the polyurethane polymer PUP is present in liquid form. If appropriate, a catalyst which accelerates the reaction of the reactive group bearing the active hydrogen with isocyanate groups may be present. This is preferred especially for the reaction of hydroxyl or mercapto groups with isocyanate groups.

The reaction products formed in this reaction are principally compounds as shown by way of example in formula (XXIV)

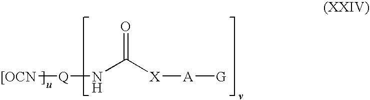

In formula (XXIV),
u is 1 or 2 or 3 or 4 or 5,
v is 1 or 2 or 3 or 4 or 5,
with the proviso that (u+v) is 2 or 3 or 4 or 5 or 6;
Q is the radical of a polyurethane:polymer PUP having (u+v) isocyanate groups after removal of all isocyanate groups;
X is X¹ or X² or X³ or X⁴;
A is A^{l} or A³ or A⁴; and
G is a capped amino group selected from the group consisting of aldimino groups of the formula (Ia) or (Ib), ketimino groups, enamino groups and oxazolidino groups.

Preferred compounds VB for the process described are the compounds VB1 of the formula (IIIa) or (IIIb) described, the compounds VB2 of the formula (XI) described, the compounds VB3 of the formula (XIV) described and the compounds VB4 of the formula (XIX) described.

Particularly preferred compounds VB for the process described are the compounds VB1 of the formula (IIIa) or (IIIb) described, the compounds VB2 of the formula (XI) described and the compounds VB4 of the formula (XIX) described.

Especially preferred compounds VB for the process described are the compounds VB1′ of the formula (V) described, which are prepared proceeding from tertiary aliphatic or cycloaliphatic aldehydes, and the compounds VB4 of the formula (XIX) described.

Most preferred compounds VB for the process described are compounds VB1″ of the formula (XXV)

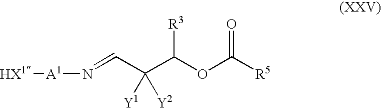

where
X^{1″} is O or S or N—R^{7″} or N—R⁸,
   where R^{7″}
   is a monovalent hydrocarbon radical which has 1 to 20 carbon atoms and optionally has at least one carboxylic ester, nitrile, nitro, phosphonic ester, sulfone or sulfonic ester group,
   or is a substituent of the formula (XXVI)

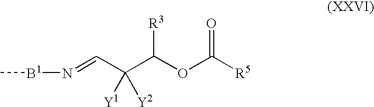

and A¹, B¹, Y¹, Y², R³, R⁵ and R⁸ are each as already defined.

These most preferred compounds VB1″ of the formula (XXV) are compounds VB1′ of the formula (V) which are prepared proceeding from aldehydes ALD2 of the formula (Xb).

In the process described, polyurethane compositions with a low isocyanate monomer content are obtained.

Owing to the random distribution of the possible reaction products, the reaction of polyols with diisocyanates to give polyurethane polymers PUP having isocyanate groups leaves a residual content of unconverted monomeric diisocyanates in the polymer formed. These monomeric diisocyanates, also referred to as “isocyanate monomers” for short, are volatile compounds and can be harmful owing to their irritant, allergenic and/or toxic action. In many fields of use, they are therefore undesired. This applies especially to spray applications and for compositions to be processed while hot, for example hotmelt adhesives.

The incomplete reaction of a polyurethane polymer PUP which has a particular content of monomeric diisocyanate with a compound VB in the manner described previously leads to a polyurethane composition which has a surprisingly low content of monomeric diisocyanates; this is significantly lower than that of the polyurethane polymer PUP before the reaction.

The surprisingly low content of monomeric diisocyanates is thought to be achieved by virtue of the fact that, in the described reaction of a polyurethane polymer PUP having isocyanate groups with at least one compound VB as described previously, the reactive group of the compound VB which bears the active hydrogen preferably reacts with the monomeric diisocyanates present in the polyurethane polymer PUP. In this way, a large portion of the diisocyanate monomers originally present is converted, even if the reaction is performed with such a stoichiometry that a proportion of the polyurethane polymer PUP does not react with the compound VB. In this way, the content of monomeric diisocyanates of a polyurethane composition can be reduced significantly.

A great advantage of the process described is that it is extremely efficient and inexpensive and additionally has the advantage that the double functionality of the monomers is not lost, such that they can be incorporated profitably into the high molecular weight polymer which forms in the course of crosslinking of the polyurethane polymers.

The content of monomeric diisocyanates in a polyurethane composition is preferably lowered to a value which corresponds to at most 50% of the starting value.

In the process described, the polyurethane polymer PUP, in the reaction with at least one compound VB, may optionally comprise further substances in the form of assistants and additives typically used in polyurethane compositions. Such further assistants and additives may, however, also be added only after the performance of the process described to the resulting polyurethane composition with a low isocyanate monomer content.

Possible assistants and additives are, for example,
plasticizers, for example carboxylic esters such as phthalates, for example dioctyl phthalate, diisononyl phthalate or diisodecyl phthalate, adipates, for example dioctyl adipate, azelates and sebacates, organic phosphoric and sulfonic esters or polybutenes;
nonreactive thermoplastic polymers, for example homo- or copolymers of unsaturated monomers, especially from the group comprising ethylene, propylene, butylene, isobutylene, isoprene, vinyl acetate or higher esters thereof, and (meth)acrylate, particularly suitable examples being ethylene-vinyl acetate copolymers (EVA), atactic poly-α-olefins (APAOs), polypropylenes (PPs) and polyethylenes (PEs);
solvents;
inorganic and organic fillers, for example ground or precipitated calcium carbonates optionally coated with stearates, carbon blacks, especially industrially produced carbon blacks (referred to hereinafter as “carbon black”), barite (BaSO4, also known as heavy spar), kaolins, aluminum oxides, aluminum hydroxides, silicas, especially high-dispersity silicas from pyrolysis processes, PVC powders or hollow spheres;
fibers, for example of polyethylene;
pigments, for example titanium dioxide or iron oxides;
catalysts which accelerate the hydrolysis of the capped amino groups, for example organic carboxylic acids such as benzoic acid, salicylic acid or 2-nitrobenzoic acid, organic carboxylic anhydrides such as phthalic anhydride, hexahydrophthalic anhydride and hexahydromethylphthalic anhydride, silyl esters of organic carboxylic acids, organic sulfonic acids such as methanesulfonic acid, p-toluenesulfonic acid or 4-dodecylbenzenesulfonic acid, sulfonic esters, other organic or inorganic acids, or mixtures of the aforementioned acids and acid esters;
catalysts which accelerate the reaction of the isocyanate groups, for example organotin compounds such as dibutyltin diacetate, dibutyltin dilaurate, dibutyltin dichloride, dibutyltin diacetylacetonate and dioctyltin dilaurate, bismuth compounds such as bismuth trioctoate and bismuth tris(neodecanoate), and compounds containing tertiary amino groups, such as 2,2′-dimorpholinodiethyl ether and 1,4-diazabicyclo[2.2.2]octane;
rheology modifiers, for example thickeners or thixotropic agents, for example urea compounds, polyamide waxes, bentonites or fumed silicas;
reactive diluents and crosslinkers, for example oligomers of diisocyanates such as MDI, TDIand IPDI, especially in the form of isocyanurates, carbodiimides, uretonimines, biurets, allophanates or iminooxadiazine-diones, adducts of diisocyanates such as MDI, TDIand IPDI with short-chain polyols, and also adipic dihydrazide and other dihydrazides;
latent hardeners with capped amino groups, for example ketimines, oxazolidines, enamines or aldimines;
desiccants, for example molecular sieves, calcium oxide, high-reactivity isocyanates such as p-tosyl isocyanate, orthoformic esters, alkoxysilanes such as tetraethoxysilane, organoalkoxysilanes such as vinyltri-methoxysilane, and organoalkoxysilanes which have a functional group in the a position to the silane group;
adhesion promoters, especially organoalkoxysilanes (“silanes”), for example epoxysilanes, vinylsilanes, (meth)acrylsilanes, isocyanatosilanes, carbamatosilanes, alkylsilanes, S-(alkylcarbonyl)mercaptosilanes and aldiminosilanes, and oligomeric forms of these silanes;
stabilizers against heat, light and UV radiation;
flame retardant substances;
surface active substances, for example wetting agents, leveling agents, devolatilizers or defoamers;
biocides, for example algicides, fungicides or substances which inhibit fungal growth.

It is advantageous to ensure that such additives do not impair the storage stability of the polyurethane composition. This means that these additives must not trigger the reactions which lead to crosslinking, such as hydrolysis of the capped amino groups or crosslinking of the isocyanate groups, to a significant degree during storage. More particularly, this means that all of these additives should contain at most traces of water, if any. It may be advisable to chemically or physically dry certain additives before they are mixed in.

The process described results in polyurethane compositions with a low isocyanate monomer content. The compositions resulting from the process described preferably have a content of monomeric diisocyanates of ≦1% by weight, especially of ≦0.5% by weight, based on the moisture-reactive constituents of the compositions.

These compositions have both isocyanate groups and capped amino groups. On contact with moisture or water, the capped amino groups are hydrolyzed and begin to react in the manner already described with isocyanate groups present. Excess isocyanate groups in relation to the isocyanate-reactive groups which are released from the hydrolysis react directly with water. As a result of these reactions, the composition cures to become a high molecular weight polymer; this process is also known as crosslinking.

The water required for the curing reaction can either originate from the air (air humidity), or else the composition can be contacted with a water-containing component, for example by spraying, or a water-containing

The composition can be applied within a wide temperature range. For example, the composition can be applied at room temperature, as is typical of an elastic adhesive or a sealant. However, the composition can also be applied at lower or else higher temperatures. The latter is advantageous especially when the composition comprises high-viscosity or meltable components, as are typically present in melt adhesives, for example warm-melt adhesives or hotmelt adhesives. The application temperatures for warm-melts are, for example, in the range from 40° C. to 80° C., and in the case of hotmelts between 85° C. and 200° C., especially between 100° C. and 150° C.

The composition crosslinks rapidly with a small amount of water and without the formation of bubbles. In the cured state, it is notable for excellent properties. It possesses, for example, a high extensibility and a high tensile strength. Its modulus of elasticity varies as a function of the components used to produce the composition, for example the polyols, polyisocyanates, and the amines used to prepare the compounds VB. It is thus possible to adjust it to the requirements of a particular application, for example to high values for adhesives or to low values for sealants.

The polyurethane composition with a low isocyanate monomer content can be used for a wide variety of different purposes. For example, it is suitable as an adhesive for the adhesive bonding of various substrates, for example for adhesive bonding of components in the production of automobiles, rail vehicles, ships or other industrial goods, especially as a reactive hotmelt adhesive, as a sealant of all kinds, for example for sealing joints in construction, and as a coating or covering for various articles or variable substrates. Preferred coatings are protective paints, seals and protective coatings, and especially primers.

In the present document, a “primer” is understood to mean a composition suitable as an undercoat, which, as well as nonreactive volatile substances and optionally solid additives, comprises at least one polymer and/or at least one substance with reactive groups, and which is capable, when applied to a substrate, of curing to a solid, firmly adhering film in a layer thickness of typically at least 10 μm, the curing resulting either solely through the evaporation of the nonreactive volatile substances, for example solvents or water, or through a chemical reaction, or through a combination of these factors, and which builds up good adhesion to a layer applied subsequently, for example an adhesive or sealant.

Preferred coverings include particularly floor coverings. Such coverings are produced by typically pouring the composition onto the substrate and leveling, where it cures to form a floor covering. For example, such floor coverings are used for offices, living areas, hospitals, schools, warehouses, garages and other private or industrial applications.

However, by their nature, the compositions are particularly suitable for applications in which a low content of monomeric diisocyanates is required. These are especially applications in which the composition is sprayed, and applications in which the composition is applied at elevated temperature, for example as a hotmelt adhesive.

The compositions obtainable from the process described can be used in a process for adhesive bonding of a substrate S1 to a substrate S2, comprising the steps of:
i) applying one of the above-described compositions to a substrate S1;
ii) contacting the applied composition with a substrate S2 within the open time of the composition;
   or
i′) applying one of the above-described compositions to a substrate

S1 and to a substrate S2;
ii′) contacting the applied compositions with one another within the open time of the composition;

wherein the substrate S2 consists of the same material or a different material than the substrate S1.

The compositions obtainable from the process described can be used in a process for sealing between a substrate S1 and a substrate S2, which comprises the step of:
i″) applying one of the above-described compositions between a substrate S1 and a substrate S2, such that the composition is in contact with the substrate S1 and the substrate S2;

wherein the substrate S2 consists of the same material or a different material than the substrate S1.

The compositions obtainable from the process described can be used in a process for coating a substrate S1, comprising the step of
i″) applying one of the above-described compositions to a substrate S1 within the open time of the composition.

When the composition is a so-called warm-melt, the composition is heated before application to a temperature of 40° C. to 80° C., especially of 60° C. to 80° C., and is applied especially at this temperature in step i) or i′) of the above-described process for adhesive bonding.

When the composition is a so-called hotmelt, the composition is heated before application to a temperature of 85° C. to 200° C., especially of 100° C. to 180° C., preferably of 120° C. to 160° C., and is applied especially at this temperature in step i) or i′) of the above-described process for adhesive bonding.

Suitable substrates S1 or S2 are, for example, inorganic substrates such as glass, glass ceramic, concrete, mortar, brick, tile, gypsum, and natural rocks such as granite or marble; metals or alloys such as aluminum, steel, nonferrous metals, zinc-plated metals; organic substrates such as leather, fabrics, paper, wood, resin-bonded wood materials, resin-textile composite materials, polymers such as polyvinyl chloride (PVC), acrylonitrile-butadiene-styrene copolymers (ABS), SMC (sheet molding composites), polycarbonate (PC), polyamide (PA), polyester, polyoxymethylene (POM), epoxy resins, polyurethanes (PU), polyolefins (PO), especially surface-plasma-, -corona- or -flame-treated polyethylene (PE) and polypropylene (PP), ethylene/propylene copolymers (EPM) and ethylene/propylene-diene terpolymers (EPDM); and also paints and paint systems, especially automotive paint systems.

These described processes for adhesive bonding, sealing or coating give rise to an article.

This article is especially a built structure, especially a built structure in construction or civil engineering, or industrial goods or consumer goods, especially a window, a domestic appliance, or a mode of transport, especially a water or land vehicle, preferably an automobile, a bus, a truck, a train or a ship, or an installable component of a mode of transport, or an article in the furniture, textile or packaging industry.

The process described is particularly suitable for preparing a hotmelt adhesive composition with a low isocyanate monomer content. To this end,
a) at least one room temperature solid polyurethane polymer PUP1 which has isocyanate groups and is as described previously is reacted with
b) at least one compound VB as described previously,

with the proviso that the ratio between the isocyanate groups of the polyurethane polymer PUP1 and the sum of the capped amino groups and the group of the compound VB which bears an active hydrogen has a value of ≧1.

This process results in reactive hotmelt adhesives with a surprisingly low isocyanate monomer content.

For the mode of action of a reactive hotmelt adhesive, it is important that the adhesive is meltable, which means that it has a sufficiently low viscosity to be applicable at the application temperature, and that it builds up an adequate adhesive strength as rapidly as possible in the course of cooling, even before the crosslinking reaction with air humidity is complete (early strength). It has been found that the hotmelt adhesives which have a low isocyanate monomer content and are obtainable from the process described have a readily manageable viscosity at the application temperatures customary for hotmelt adhesives, in the range from 85° C. to 200° C., t_{y}pically 120° C. to 160° C., and that they build up good adhesive strength sufficiently rapidly in the course of cooling.

In the course of application, such a hotmelt adhesive comes into contact with moisture, especially in the form of air humidity. In parallel to the physical hardening owing to solidification in the course of cooling, chemical crosslinking with moisture also sets in, principally by virtue of the aldimino groups present being hydrolyzed by moisture and reacting rapidly with isocyanate groups present in the manner already described. Excess isocyanate groups likewise crosslink with moisture in a known manner.

A hotmelt adhesive obtainable from the process described exhibits a greatly reduced tendency to form bubbles in the course of crosslinking with moisture, since only a small amount of carbon dioxide or none at all—according to the stoichiometry—is formed in the course of crosslinking as a result of the presence of capped amino groups.

### EXAMPLES

### Description of the Test Methods

Infrared spectra were measured on an FT-IR 1600 instrument from Perkin-Elmer (horizontal ATR analysis unit with ZnSe crystal), and the substances were applied undiluted as a film. The absorption bands are reported in wavenumbers (cm⁻¹) (measurement window: 4000-650 cm⁻¹).

¹H NMR spectra were measured on a Bruker DPX-300 spectrometer at 300.13 MHz. The chemical shifts δ are reported in ppm relative to tetramethylsilane (TMS), coupling constants are reported in Hz. True coupling patterns and pseudo-coupling patterns were not distinguished.

The viscosity was measured at the temperature specified on a thermostated Physica UM cone-plate viscometer (cone diameter 20 mm, cone angle 1°, cone tip-plate distance 0.1 mm, shear rate 10 to 1000 s⁻¹).

The amine content of the dialdimines prepared, i.e. the content of protected amino groups in the form of aldimino groups, was determined titrimetrically (with 0.1N HClO₄ in glacial acetic acid, using crystal violet), and is always reported in mmol N/g.

The content of monomeric diisocyanates was determined by means of HPLC (detection by means of a photodiode array; 0.04 M sodium acetate/acetonitrile as mobile phases) and is reported in % by weight based on the overall composition.

The tensile strength, the elongation at break and the modulus of elasticity were determined based on DIN 53504, on dumbbells with a thickness of 1 mm and a length of 75 mm (central element length 30 mm, central element width 4 mm). To produce the dumbbells, an adhesive film of thickness 1 mm was prepared (application temperature of the adhesive 130° C.), from which the dumbbells were punched out, which were then stored at 23° C. and 50% relative air humidity over the time specified.

a) Preparation of Compounds with a Capped Amino Group and Group Bearing Active Hydrogen

Compound VB-01

A round-bottom flask with water separator and stirrer was initially charged with 10.00 g of 2-(2-aminoethoxy)ethanol (Diglycolamine® Agent; Huntsman), 13.83 g of cyclohexanone and 100 ml of cyclohexane, and the mixture was heated under reflux until the calculated amount of water had separated out. Thereafter, the volatile constituents of the reaction mixture were removed under reduced pressure (10 mbar, 100° C.). Yield: 17.5 g of a pale yellow, clear liquid with an amine content of 5.20 mmol N/g.

IR: 3360br and 3200br (O—H), 2926, 2854, 1658 (C═N), 1448, 1346, 1312, 1278, 1261, 1238, 1229sh, 1124_{;} 1062, 1029sh, 972, 916, 892, 873, 858, 836, 806, 772, 744, 660.

Compound VB-02

A round-bottom flask with water separator and stirrer was initially charged with 15.00 g of 3-amino-1-propanol, 30.00 g of 3,3-dimethyl-2-butanone and 100 ml of cyclohexane, and the mixture was heated under reflux until the calculated amount of water had separated out. The volatile constituents of the reaction mixture were then removed under reduced pressure (10 mbar, 70° C.). Yield: 29.8 g of a colorless, clear liquid with an amine content of 6.37 mmol N/g.

IR: 3350br (O—H), 2960, 2928, 2868, 1650 (C═N), 1474sh, 1464, 1432, 1390, 1362, 1285, 1220, 1202, 1146, 1058, 1028, 994, 946, 927, 914, 834, 808, 713.

Compound VB-03

A round-bottom flask with water separator and stirrer was initially charged with 20.00 g of N-(2-hydroxyethyl)piperazine, 15.83 g of cyclohexanone, 0.4 g of formic acid and 100 ml of cyclohexane, and the mixture was heated under reflux until the calculated amount of water had separated out. The volatile constituents of the reaction mixture were then removed under reduced pressure (10 mbar, 100° C.). Yield: 31.3 g of a pale yellow, clear liquid with an amine content of 9.37 mmol N/g.

IR: 3385br (O—H), 3056, 2922, 2881, 2855, 2812, 2765sh, 2695, 1644 (C═C), 1452, 1386, 1346, 1300, 1282, 1270, 1204, 1188sh, 1138, 1056, 1039sh, 1016sh, 1008, 976, 952, 930, 917, 894, 876, 836, 788, 688, 666.

Compound VB-04

A round-bottom flask with water separator and stirrer was initially charged, under a nitrogen atmosphere, with 20.00 g of diethanolamine, 15.10 g of isobutyraldehyde and 100 ml of cyclohexane, and the mixture was heated under reflux until the calculated amount of water had separated out. The volatile constituents of the reaction mixture were then removed under reduced pressure (10 mbar, 70° C.). Yield: 30.8 g of a colorless, clear liquid with an amine content of 6.33 mmol N/g.

IR: 3420br (O—H), 2956, 2931sh, 2872, 2810, 2706, 1731, 1470, 1390, 1360, 1327, 1292, 1221, 1194, 1164, 1142, 1118, 1056, 954, 934, 897sh, 880, 847, 812, 678.

Compound VB-05

A round-bottom flask with water separator and stirrer was initially charged, under a nitrogen atmosphere, with 5.00 g of 2-(2-aminoethoxy)ethanol (Diglycolamine® Agent; Huntsman), 5.00 g of pivalaldehyde and 100 ml of cyclohexane, and the mixture was heated under reflux until the calculated amount of water had separated out. The volatile constituents of the reaction mixture were then removed under reduced pressure (10 mbar, 70° C.). Yield: 7.9 g of a colorless, clear liquid with an amine content of 5.93 mmol N/g and a viscosity of 10 mPa·s at 20° C.

IR: 3375br (O—H), 2956, 2933, 2927, 2902, 2864, 2710br, 1666 (C═N), 1476, 1458, 1396, 1362, 1340sh, 1278, 1230sh, 1212, 1126, 1060, 958sh, 942, 920, 894, 812, 776.

Compound VB-06

A round-bottom flask was initially charged, under a nitrogen atmosphere, with 10.00 g of 2-(2-aminoethoxy)ethanol (Diglycolamine® Agent; Huntsman). With vigorous stirring, 10.34 g of benzaldehyde were added slowly from a dropping funnel, in the course of which the mixture heated up. Thereafter, the volatile constituents were removed under reduced pressure (10 mbar, 70° C.). Yield: 18.5 g of a yellow, clear liquid with an amine content of 5.07 mmol N/g and a viscosity of 75 mPa·s at 20° C.

IR: 3380br (O—H), 3084, 3061, 3029, 2934sh, 2909sh, 2858, 1959br, 1897br, 1823br, 1700, 1644 (C═N), 1600, 1580, 1492, 1450, 1378, 1342, 1312, 1294, 1220, 1170, 1122, 1062, 1027, 1002sh, 968, 931, 892, 853, 810, 754, 692.

Compound VB-07

A round-bottom flask was initially charged, under a nitrogen atmosphere, with 16.74 g of 3-acetoxy-2,2-dimethylpropanal. With vigorous stirring, 12.00 g of 2-(2-aminoethoxy)ethanol (Diglycolamine® Agent; Huntsman) were added slowly from a dropping funnel, in the course of which the mixture heated up.

Thereafter, the volatile constituents were removed under reduced pressure (10 mbar, 100° C.). Yield: 26.5 g of a colorless, clear liquid with an amine content of 4.25 mmol N/g and a viscosity of 10 mPa·s at 20° C.

IR: 3415br (O—H), 2962, 2928, 2914, 2902, 2888sh, 2866, 2849sh, 2722br, 1736 (C═O), 1666 (C═N), 1470, 1458sh, 1439sh, 1395, 1374, 1234, 1126, 1038, 1009, 988, 931, 894, 847, 814, 793sh.

¹H NMR (CDCl₃, 300 K): δ 7.59 (t, 1H, J≈1.3, CH═N), 4.03 (s, 2H, CH₂O), 3.71 (m, 4H, HOCH₂CH₂OCH₂CH₂N), 3.58 (m, 4H, HOCH₂CH₂OCH₂CH₂N), 3.06 (s, 1H, OH), 2.06 (s, 3H, CH₃CO), 1.11 (s, 6H, C(CH₃)₂).

Compound VB-08

A round-bottom flask was initially charged, under a nitrogen atmosphere, with 14.39 g of 3-acetoxy-2,2-dimethylpropanal. With vigorous stirring, 10.00 g of solid 5-amino-1-pentanol were added in portions, in the course of which the latter went into solution and the mixture heated up. Thereafter, the volatile constituents were removed under reduced pressure (10 mbar, 100° C.). Yield: 22.4 g of a colorless, clear liquid with an amine content of 4.28 mmol N/g and a viscosity of 50 mPa·s at 20° C.

IR: 3380br (O—H), 2932, 2860, 2723br, 1738 (C═O), 1666 (C═N), 1470, 1458, 1437sh, 1395, 1374, 1238, 1069sh, 1038, 1012sh, 988, 928, 891, 846, 775,734.

¹H NMR (CDCl₃, 300 K): δ 7.52 (t, 1H, J≈1.2, CH═N), 4.02 (s, 2H, CH₂O), 3.63 (t, 2H, J≈6.5, HOCH₂CH₂CH₂), 3.39 (t×d, 2H, J≈6.9/1.2, CH═NCH₂CH₂), 2.11 (s, 1H, OH), 2.05 (s, 3H, CH₃CO), 1.60 (m, 4H, HOCH₂CH₂CH₂ and CH═NCH₂CH₂), 1.36 (m, 2H, HOCH₂CH₂CH₂), 1.11 (s, 6H, C(CH₃)₂).

Compound VB-09

A round-bottom flask was initially charged, under a nitrogen atmosphere, with 15.94 g of 3-acetoxy-2,2-dimethylpropanal. With vigorous stirring, 12.00 g of bis(hexamethylenetriamine) (BHMT-HP; Invista) which had been liquified at 60° C. were pipetted in in portions, in the course of which the mixture heated up. Thereafter, the volatile constituents were removed under reduced pressure (10 mbar, 100° C.). Yield: 26.1 g of a colorless, clear liquid with an amine content of 6.24 mmol N/g and a viscosity of 60 mPa·s at 20° C.

IR: 3313 (N—H), 2963sh, 2928, 2852, 2826, 1738 (C═O), 1668 (C═N), 1468, 1437sh,1394,1374,1339sh,1234,1128,1038,1011sh,986, 928, 844, 730, 668.

¹H NMR (CDCl₃, 300 K): δ 7.51 (t, 2H, J≈1.2, CH═N), 4.02 (s, 4H, CH₂O), 3.36 (t×d, 4H, J≈6.9/1.2, CH═NCH₂CH₂), 2.58 (t, 4H, J≈7.2, NHCH₂CH₂CH₂), 2.04 (s, 6H, CH₃CO), 1.63-1.43 (m, 9H, CH═NCH₂CH₂and NHCH₂CH₂CH₂), 1.30 (m, 8H, CH═NCH₂CH₂CH₂ and NHCH₂CH₂CH₂), 1.10 (s, 12H, C(CH₃)₂).

b) Preparation of polyurethane polymers

Polyurethane Polymer PUP-1

780 g of Dynacoll® 7360 polyol (Degussa; crystalline polyesterdiol, OH number 32 mg KOH/g, acid number approx. 2 mg KOH/g) and 120 g of 4,4′-methylenediphenyl diisocyanate (MDI; Desmodur® 44 MC L, Bayer) were converted by a known method at 80° C. to an NCO-terminated polyurethane polymer. The room temperature solid reaction product had a content of free isocyanate groups, determined titrimetrically, of 1.97% by weight.

Polyurethane Polymer PUP-2

435 g of Dynacoll® 7360 polyol (Degussa; crystalline polyesterdiol, OH number 32 mg KOH/g, acid number approx. 2 mg KOH/g) and 65 g of isophorone diisocyanate (IPDI; Vestanat® IPDI, Degussa) were converted by a known method at 80° C. to an NCO-terminated polyurethane polymer. The room temperature solid reaction product had a content of free isocyanate groups determined titrimetrically of 2.25% by weight.

### c) Production of Hotmelt Adhesives

### Examples 1 to 6 and Comparative Example 7

For each example, the particular constituents according to table 1 were heated to 100° C. and weighed under a nitrogen atmosphere in the parts by weight specified into a screwtop polypropylene cup, and mixed by means of a centrifugal mixer (SpeedMixer™ DAC 150, FlackTek Inc.; 1 min at 3000 rpm). Immediately thereafter, the mobile mixture thus obtained was transferred into an internally coated aluminum tube which was sealed airtight and stored at 100° C. over one hour.

TABLE 1
Composition of the hotmelt adhesives of examples 1 to 6 and of
comparative example 7.

| | Example | | | | | | |
|---|---|---|---|---|---|---|---|
| | 1 | 2 | 3 | 4 | 5 | 6 | 7 (Comp.) |
| PU polymer PUP-1 | 50.0 | 50.0 | 50.0 | 50.0 | 50.0 | 50.0 | 50.0 |
| Compound | VB-04 | VB-05 | VB-06 | VB-07 | VB-08 | VB-09 | — |
| | 1.11 | 1.78 | 2.08 | 2.49 | 2.47 | 3.38 | |

In examples 1 to 6, the ratio between the isocyanate groups of the polyurethane polymer PUP-1 and the sum of the groups reactive toward isocyanate groups (free and capped hydroxyl groups, free and capped amino groups) in the compounds VB-04 to VB-09 is 1.0/0.9.

The hotmelt adhesives of examples 1 to 6 and of comparative example 7 thus produced were tested for viscosity and content of monomeric 4,4′-methylenediphenyl diisocyanate (4,4′-MDI). The tensile strength, elongation at break and modulus of elasticity were measured on the adhesive film which had been stored over 7 days. The results are shown in table 2.

TABLE 2
Properties of the hotmelt adhesives of examples 1 to 6 and of
comparative example 7.

| | Example | | | | | | |
|---|---|---|---|---|---|---|---|
| | 1 | 2 | 3 | 4 | 5 | 6 | 7 (Comp.) |
| Content of monomeric | 0.37 | 0.09 | 0.11 | 0.21 | 0.34 | 0.43 | 1.59 |
| 4,4′-MDI [% by weight] | | | | | | | |
| Viscosity at 130° C. [Pa · s] | 21.2 | 15.8 | 14.6 | 6.2 | 6.4 | 9.0 | 7.0 |
| Tensile strength [MPa] | 28.4 | 20.3 | 20.0 | 18.1 | 21.1 | 26.0 | 18.7 |
| Elongation at break [%] | 540 | 730 | 670 | 730 | 650 | 360 | 510 |
| Modulus of elasticity at | 290 | 225 | 220 | 195 | 235 | 220 | 315 |
| 0.5-5.0% [MPa] | | | | | | | |

It is evident from table 2 that the hotmelt adhesives of examples 1 to 6 produced by means of the process according to the invention have a readily manageable viscosity and cure within 7 days to give a well-crosslinked polymer which has a high tensile strength, a high elongation at break and a high modulus of elasticity. Compared to the hotmelt adhesive of comparative example 7, they have a significantly lower content of monomeric 4,4′-MDI, the process according to the invention lowering this content to values between 6% and 27% of the starting value.

### Examples 8 to 13 and Comparative Example 14

For each example, the particular constituents according to table 3 were heated to 100° C. and weighed under a nitrogen atmosphere in the parts by weight specified into a screwtop polypropylene cup and mixed by means of a centrifugal mixer (SpeedMixer™ DAC 150, FlackTek Inc.; 1 min at 3000 rpm).

Immediately thereafter, the mobile mixture thus obtained was filled into an internally coated aluminium tube which was sealed airtight and stored at 100° C. over 1 hour.

TABLE 3
Composition of the hotmelt adhesives of examples 8 to 13 and of
comparative example 14.

| | Example | | | | | | |
|---|---|---|---|---|---|---|---|
| | 8 | 9 | 10 | 11 | 12 | 13 | 14 (Comp.) |
| PU polymer PUP-2 | 50.0 | 50.0 | 50.0 | 50.0 | 50.0 | 50.0 | 50.0 |
| Compound | VB-01 | VB-02 | VB-03 | VB-04 | VB-05 | VB-07 | — |
| | 2.32 | 1.90 | 2.57 | 1.27 | 2.03 | 2.84 | |

In examples 8 to 13, the ratio between the isocyanate groups of the polyurethane polymer PUP-2 and the sum of the groups reactive toward isocyanate groups (free and capped hydroxyl groups, free and capped amino groups) in the compounds VB-01 to VB-05, and VB-07, is 1.0/0.9.

The hotmelt adhesives of examples 8 to 13 and of comparative example 14 thus produced were tested for viscosity and content of monomeric isophorone diisocyanate (IPDI; sum of cis and trans isomers). The tensile strength, elongation at break and modulus of elasticity were measured on the adhesive film which had been stored over 3 weeks. The results are shown in table 4.

TABLE 4
Properties of the hotmelt adhesives of examples 8 to 13 and of
comparative example 14.

| | Example | | | | | | |
|---|---|---|---|---|---|---|---|
| | 8 | 9 | 10 | 11 | 12 | 13 | 14 (Comp.) |
| Content of monomeric IPDI | 0.04 | 0.22 | 0.02 | 0.65 | 0.10 | 0.21 | 2.32 |
| [% by weight] | | | | | | | |
| Viscosity at 130° C. [Pa · s] | 12.0 | 5.8 | 20.2 | 3.4 | 3.3 | 2.4 | 2.1 |
| Tensile strength [MPa] | 19.7 | 19.3 | 12.4 | 25.3 | 20.3 | 17.7 | 18.2 |
| Elongation at break [%] | 700 | 620 | 12 | 420 | 800 | 800 | 9 |
| Modulus of elasticity at | 195 | 230 | 205 | 290 | 230 | 200 | 305 |
| 0.5-5.0% [MPa] | | | | | | | |

It is evident from table 4 that the hotmelt adhesives of examples 8 to 13 produced by means of the process according to the invention have a readily manageable viscosity and cure within 3 weeks to give a well-crosslinked polymer which has a high tensile strength, a high elongation at break and a high modulus of elasticity. Compared to the hotmelt adhesive of comparative example 14, they have a significantly lower content of monomeric IPDI, the process according to the invention lowering this content to values between 1% and 28% of the starting value. The hotmelt adhesive of comparative example 14 is still not completely crosslinked after 3 weeks and therefore has inadequate elongation at break.

1. A process for preparing a polyurethane composition with a low content of monomeric diisocyanates, wherein:
a) at least one polyurethane polymer PUP having isocyanate groups is reacted with
b) at least one compound VB bearing an active hydrogen;
with the proviso that the ratio between the isocyanate groups of the polyurethane polymer PUP and the sum of the capped amino groups and the group of the compound VB which bears an active hydrogen has a value of ≧1;
where the compound VB has both
i) a group which bears an active hydrogen and is a hydroxyl group or a mercapto group or a secondary amino group
and
ii) at least one capped amino group selected from the group consisting of aldimino groups of the formula (Ia) or (Ib), ketimino groups, enamino groups and oxazolidino groups, 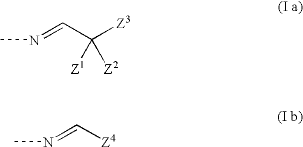
where, in formula (Ia),
Z¹ and Z² are
each independently a hydrogen atom or a monovalent hydrocarbon radical having 1 to 12 carbon atoms,
or
together are a divalent hydrocarbon radical which has 4 to 20 carbon atoms and is part of an optionally substituted carbocyclic ring having 5 to 8 carbon atoms; and
Z³
is a hydrogen atom,
or is a branched or unbranched alkyl, cycloalkyl, alkylene or cycloalkylene group,
or is a substituted or unsubstituted aryl or arylalkyl group,
or is a radical of the formula O—R² or 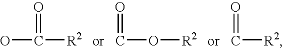
where R² is an aryl, arylalkyl or alkyl group and is in each case substituted or unsubstituted, or is a radical of the formula (II) 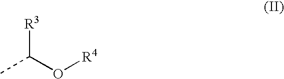
where, in formula (II),
R³ is a hydrogen atom or an alkyl or arylalkyl group, and
R⁴
is a hydrocarbon radical which has 1 to 30 carbon atoms and optionally contains ether oxygen atoms,
or is a 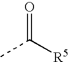
radical where R⁵ is a hydrogen atom or a hydrocarbon radical having 1 to 5 carbon atoms,
and where, in formula (Ib),
Z⁴
is a substituted or unsubstituted aryl or heteroaryl group which has a ring size of 5 to 8 atoms,
or is 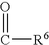
where R⁶
is a hydrogen atom or an alkoxy group,
or is a substituted or unsubstituted alkenyl or arylalkenyl group having at least 6 carbon atoms.

2. The process as claimed in claim 1, wherein the polyurethane polymer PUP having isocyanate groups is a room temperature solid polyurethane polymer PUP1, and has a molecular weight of 1000 to 10 000 g/mol.

3. The process as claimed in claim 1 wherein the compound VB bearing an active hydrogen is a compound VB1 which has aldimino groups and is of the formula (IIIa) or (IIIb) 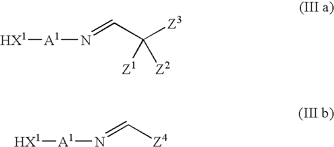
where
A¹
is a divalent hydrocarbon radical which has 2 to 20 carbon atoms and optionally has heteroatoms,
or, together with R⁸, is a trivalent hydrocarbon radical which has 3 to 20 carbon atoms and optionally contains at least one heteroatom;
X¹ is O or S or N—R⁷ or N—R⁸,
where R⁷
is a monovalent hydrocarbon radical which has 1 to 20 carbon atoms and optionally has at least one carboxylic ester, nitrile, nitro, phosphonic ester, sulfone or sulfonic ester group,
or is a substituent of the formula (IVa) or (IVb) 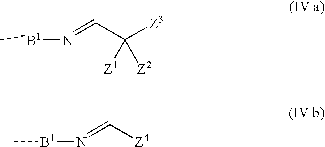
where B¹ is a divalent hydrocarbon radical which has 2 to 20 carbon atoms and optionally has heteroatoms, and
R⁸, together with A′, is a trivalent hydrocarbon radical which has 3 to 20 carbon atoms and optionally contains at least one heteroatom.

4. The process as claimed in claim 3, wherein the compound VB bearing an active hydrogen is a compound VB1′ which has aldimino groups and is of the formula (V) 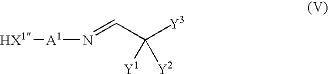
where
Y¹ and Y²
are each independently a monovalent hydrocarbon radical having 1 to 12 carbon atoms,
or together are a divalent hydrocarbon radical which has 4 to 12 carbon atoms and is part of an optionally substituted carbocyclic ring having 5 to 8 carbon atoms;
Y³
is a branched or unbranched alkyl, cycloalkyl, alkylene or cycloalkylene group, or is a substituted or unsubstituted aryl or arylalkyl group,
or is a radical of the formula O—-R² or 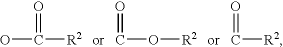
or is a radical of the formula (II) 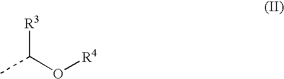
X^{1′} is O or S or N—R^{7′} or N—R⁸,
where R⁷
is a monovalent hydrocarbon radical which has 1 to 20 carbon atoms and optionally has at least one carboxylic ester, nitrile, nitro, phosphonic ester, sulfone or sulfonic ester group,
or is a substituent of the formula (VI)

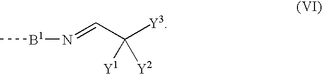

5. The process as claimed in claim 4, wherein the compound VB bearing an active hydrogen is a compound VB1″ which has aldimino groups and is of the formula (XXV) 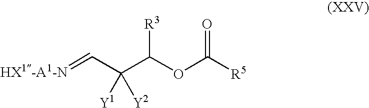
where
X^{1″} is O or S or N—R^{7″} or N—R⁸,
where R^{7″}
is a monovalent hydrocarbon radical which has 1 to 20 carbon atoms and optionally has at least one carboxylic ester, nitrile, nitro, phosphonic ester, sulfone or sulfonic ester group,
or is a substituent of the formula (XXVI)

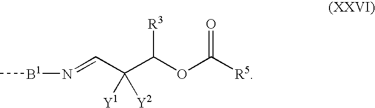

6. The process as claimed in claim 3, wherein the compound VB1 of the formula (IIIa) or (IIIb) is obtained from the reaction of at least one amine B1 of the formula (VII) with at least one aldehyde ALD of the formula (VIIIa) or (VIIIb) 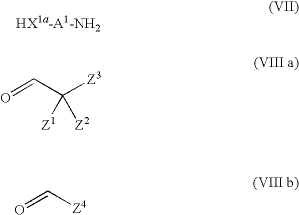
where
X^{1a} is O or S or N—R⁹ or N—R⁸,
where R⁹
is a monovalent hydrocarbon radical which has 1 to 20 carbon atoms and optionally has at least one carboxylic ester, nitrile, nitro, phosphonic ester, sulfone or sulfonic ester group,
or is a substituent of the formula (VIIa) 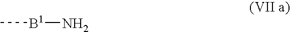
and where the aldehyde ALD, in relation to the primary amino groups of the amine B1, is used stoichiometrically or in a stoichiometric excess.

7. The process as claimed in claim 6, wherein the aldehyde ALD is not enolisable, and more particularly does not have a hydrogen atom in the a position to the carbonyl group.

8. The process as claimed in claim 6, wherein the aldehyde ALD is an aldehyde of the formula (VIIIb) or of the formula (IX).

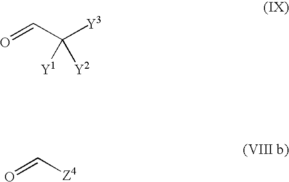

9. The process as claimed in claim 6, wherein the aldehyde ALD is an aldehyde ALD1 of the formula (Xa) 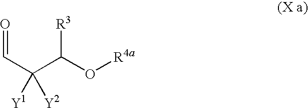
where R^{4a} is a hydrocarbon radical which has 1 to 30 carbon atoms, and optionally contains ether oxygen atoms;
and the aldehyde ALD1 is selected from the group consisting of 2,2-dimethyl-3-phenoxypropanal, 3-cyclohexyloxy-2,2-dimethylpropanal, 2,2-dimethyl-3-(2-ethylhexyloxy)propanal, 2,2-dimethyl-3-lauroxypropanal and 2,2-dimethyl-3-stearoxypropanal.

10. The process as claimed in claim wherein the aldehyde ALD is an aldehyde ALD2 of the formula (Xb) 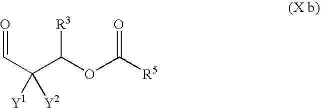
where R⁵ is a hydrogen atom or a hydrocarbon radical having 1 to 5 carbon atoms;
and the aldehyde ALD2 is selected from the group consisting of 2,2-dimethyl-3-formyloxypropanal, 3-acetoxy-2,2-dimethylpropanal, 2,2-dimethyl-3-propionoxypropanal, 3-butyroxy-2,2-dimethylpropanal, 2,2-dimethyl-3-isobutyroxypropanal, 2,2-dimethyl-3-pentoyloxypropanal and 2,2-dimethyl-3-hexoyloxypropanal.

11. The process as claimed in claim 6, wherein the aldehyde ALD is selected from the group consisting of benzaldehyde, 2- and 3- and 4-tolualdehyde, 4-ethyl- and 4-propyl- and 4-isopropyl- and 4-butylbenzaldehyde, 2,4-dimethylbenzaldehyde, 2,4,5-trimethylbenzaldehyde, 4-acetoxybenz-aldehyde, 4-anisaldehyde, 4-ethoxybenzaldehyde, the isomeric di- and trialkoxybenzal-dehydes, 2-, 3- and 4-nitrobenzaldehyde, 2-, 3- and 4-formylpyridine, 2-furfuraldehyde, 2-thiophenecarbaldehyde, 1- and 2-naphthylaldehyde, 3- and 4-phenyloxybenzaldehyde; quinoline-2-carbaldehyde and the 3, 4, 5, 6, 7 and 8 positional isomers thereof, and anthracene-9-carbaldehyde; and glyoxal, glyoxalic esters, for example methyl glyoxalate, cinnamaldehyde and substituted cinnamaldehydes.

12. The process as claimed in claim 1, wherein the compound VB bearing an active hydrogen is a compound VB2 which has ketimino groups and is of the formula (XI) 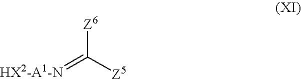
where
A¹
is a divalent hydrocarbon radical which has 2 to 20 carbon atoms and optionally has heteroatoms,
or together with R⁸ is a trivalent hydrocarbon radical which has 3 to 20 carbon atoms and optionally contains at least one heteroatom;
X² is O or S or N—R¹⁰ or N—R⁸,
where R¹⁰
is a monovalent hydrocarbon radical which has 1 to 20 carbon atoms and optionally has at least one carboxylic ester, nitrile, nitro, phosphonic ester, sulfone or sulfonic ester group,
or is a substituent of the formula (XII); 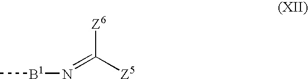
where B¹ is a divalent hydrocarbon radical which has 2 to 20 carbon atoms and optionally has heteroatoms, and
R⁸ together with A¹ is a trivalent hydrocarbon radical which has 3 to 20 carbon atoms and optionally contains at least one heteroatom;
and
Z⁵ and Z⁶
are each independently a monovalent hydrocarbon radical having 1 to 12 carbon atoms,
or
together are a divalent hydrocarbon radical which has 4 to 20 carbon atoms and is part of an optionally substituted carbocyclic ring having 5 to 8 carbon atoms.

13. The process as claimed in claim 12, wherein Z⁵ and Z⁶ are each independently an unbranched or especially branched alkyl radical having 1 to 6 carbon atoms,
or together are an alkyl radical which has 4 to 10 carbon atoms and is part of an optionally substituted carbocyclic ring having 5 or 6 carbon atoms,
and/or X² is preferably O or N—R¹⁰ or N—R⁸.

14. The process as claimed in claim 1, wherein the compound VB bearing an active hydrogen is a compound VB3 which has enamino groups and is of the formula (XIV) 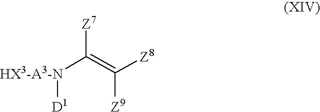
where
A³
is a divalent hydrocarbon radical which has 2 to 20 carbon atoms and optionally has heteroatoms,
or
together with D¹ or together with R¹² is a trivalent hydrocarbon radical which has 3 to 20 carbon atoms and optionally contains at least one heteroatom,
X³ is O or S or N—R¹¹ or N—R¹²,
where R¹¹
is a monovalent hydrocarbon radical which has 1 to 20 carbon atoms and optionally has at least one carboxylic ester, nitrile, nitro, phosphonic ester, sulfone or sulfonic ester group,
or is a substituent of the formula (XV) 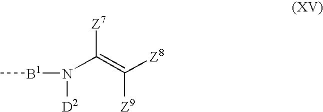
where B¹ is a divalent hydrocarbon radical which has 2 to 20 carbon atoms and optionally has heteroatoms, and
D² is a monovalent hydrocarbon radical having 1 to 12 carbon atoms,
and R¹², either together with A³ or together with D¹, is a trivalent hydrocarbon radical which has 3 to 20 carbon atoms and optionally contains at least one heteroatom;
Z⁷ and Z⁸
are each independently a hydrogen atom or a monovalent hydrocarbon radical having 1 to 12 carbon atoms, or
together are a divalent hydrocarbon radical which has 3 to 20 carbon atoms and is part of an optionally substituted carbocyclic ring having 5 to 8 carbon atoms;
Z⁹ is a hydrogen atom or a monovalent hydrocarbon radical having 1 to 12 carbon atoms; and
D¹
is a monovalent hydrocarbon radical having 1 to 12 carbon atoms,
or
together with R¹² or together with A³ is a trivalent hydrocarbon radical which has 4 to 20 carbon atoms and optionally contains at least one heteroatom.

15. The process as claimed in claim 14, wherein Z⁷, Z⁸ and Z⁹ are each independently a hydrogen atom or an alkyl radical having 1 to 4 carbon atoms.

16. The process as claimed in claim 1, wherein the compound VB bearing an active hydrogen is a compound VB4 which has oxazolidino groups and is of the formula (XIX) 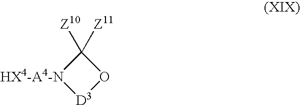
where
A⁴ is a divalent hydrocarbon radical which has 2 to 20 carbon atoms and optionally has heteroatoms;
Z¹⁰ and Z¹¹ are each independently a hydrogen atom or a monovalent hydrocarbon ^{radical} having 1 to 12 carbon atoms,
D³ is an optionally substituted alkylene radical having 2 or 3 carbon atoms,
and
X⁴ is O or S or N—R¹⁴
where R¹⁴
is a monovalent hydrocarbon radical which has 1 to 20 carbon atoms and optionally has at least one carboxylic ester, nitrile, nitro, phosphonic ester, sulfone or sulfonic ester group,
or is a substituent of the formula (XX) 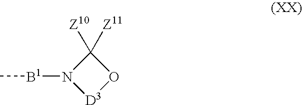
where B¹ is a divalent hydrocarbon radical which has 2 to 20 carbon atoms and optionally has heteroatoms.

17. The process as claimed in claim 16, wherein
Z¹⁰ is a hydrogen atom and Z¹¹ is an alkyl radical having 1 to 8 carbon atoms and/or
A⁴ is an optionally substituted alkylene radical having 2 or 3 carbon atoms and/or X⁴ is O.

18. The process as claimed in claim 1, wherein it lowers the content of monomeric diisocyanates in a polyurethane composition to a value which corresponds to at most 50% of the starting value.

19. A composition having a content of monomeric diisocyanates of ≦1% by weight based on the moisture-reactive constituents of the composition, wherein the composition is obtainable from a process for preparing a polyurethane composition with a low isocyanate monomer content as claimed in claim 1.

20. A process for adhesive bonding of a substrate S1 to a substrate S2, comprising the steps of
i) applying a composition as claimed in claim 19 to a substrate S1;
ii) contacting the applied composition with a substrate S2 within the open time of the composition;
or
i′) applying a composition as claimed in claim 19 to a substrate S1 and to a substrate S2;
ii′) contacting the applied compositions with one another within the open time of the composition;
wherein the substrate S2 consists of the same material or a different material than the substrate S1.

21. A process for sealing, comprising the step of
i″) applying a composition as claimed in claim 19 between a substrate S1 and a substrate S2, such that the composition is in contact with the substrate S1 and the substrate S2;
wherein the substrate S2 consists of the same material or a different material than the substrate S1.

22. A process for coating a substrate S1, comprising the step of
i′″) applying a composition as claimed in claim 19 to a substrate S1 within the open time of the composition.

23. The process as claimed in claim 20, wherein the composition, before being applied, is heated to a temperature of 40° C. to 80° C. and is applied especially at this temperature step i) or i′) or i″).

24. The process as claimed in claim 20, wherein the composition, before being applied, is heated to a temperature of 85° C. and is applied especially at this temperature in step i) or i′) or i″).

25. An article which has been adhesive bonded, sealed or coated by a process as claimed in claim 20.

26. The article as claimed in claim 25, wherein the article is a built structure or industrial goods or consumer goods or a mode of transport or an installable component of a mode of transport, or an article in the furniture, textile or packaging industry.
